(19) United States
(12) Patent Application Publication
(10) Pub. No.: US 2025/0284947 A1
(43) Pub. Date: Sep. 11, 2025

(54) THERMODYNAMIC COMPUTING SOFTMAX GADGET

(71) Applicant: Extropic Corp., Austin, TX (US)

(72) Inventors: Christopher Chamberland, Austin, TX (US); Guillaume Verdon-Akzam, San Francisco, CA (US)

(73) Assignee: Extropic Corp., Austin, TX (US)

(21) Appl. No.: 18/811,122

(22) Filed: Aug. 21, 2024

Related U.S. Application Data
(60) Provisional application No. 63/562,565, filed on Mar. 7, 2024.

(51) Int. Cl. G06N 3/065; G06N 3/048

(52) U.S. Cl. CPC G06N 3/065; G06N 3/048

(57) ABSTRACT

An analog SoftMax gadget is implemented using one or more thermodynamic chips (neuro-thermodynamic processors). The analog SoftMax gadget takes a thermodynamic input and calculates a result of the SoftMax function thermodynamically according to an engineered potential used for oscillators and oscillator couplings for a set of oscillators that implement the analog SoftMax gadget. The analog SoftMax gadget returns the result of the SoftMax function as a thermodynamic output that may be relayed to other energy-based models of a thermodynamic computer. The input, processing, and output are all performed thermodynamically (e.g., in an analog fashion) without a need to convert the information into a classical representation.

### RELATED APPLICATION

This application claims benefit of priority to U.S. Provisional Application Ser. No. 63/562,565, entitled “Transformer-Based Architectures Using Thermodynamic Computing,” filed Mar. 7, 2024, and which is incorporated herein by reference in its entirety.

### BACKGROUND

### Description of Related Art

Various algorithms, such as machine learning algorithms, often use statistical probabilities to make decisions or to model systems. Some such learning algorithms may use Bayesian statistics, or may use other statistical models that have a theoretical basis in natural phenomena. Also, machine learning algorithms themselves may be implemented using Bayesian statistics, or may use other statistical models that have a theoretical basis in natural phenomena.

Generating such statistical probabilities may involve performing complex calculations which may require both time and energy to perform, thus increasing a latency of execution of the algorithm and/or negatively impacting energy efficiency. In some scenarios, calculation of such statistical probabilities using classical computing devices may result in non-trivial increases in execution time of algorithms and/or energy usage to execute such algorithms.

As an alternative, algorithms may be performed using thermodynamic computers. However, communication between multiple energy-based models implemented on a thermodynamic computing device and/or communications between thermodynamic computing devices may require converting information into a classical computing device form, thus reducing at least some of the benefits of a thermodynamic computer implementation. Also, such algorithms may include various functions that may need to be performed on the thermodynamic information, wherein performing the functions without converting the thermodynamic information into a classical computing device form speeds execution and avoids potential measurement errors.

### BRIEF DESCRIPTION OF THE DRAWINGS

FIG. 1A is high-level diagram illustrating an energy-based model (EBM) implemented using a thermodynamic chip and an analog SoftMax gadget implemented using a thermodynamic chip, wherein the EBM and analog SoftMax gadget are shown at a first moment in time (e.g. prior to a coupling between oscillators of the SoftMax gadget and oscillators of the EBM, wherein the coupling (performed directly or via relay oscillators) provides input values for a SoftMax function that is performed thermodynamically), according to some embodiments.

FIG. 1B illustrates the EBM and analog SoftMax gadget at a second moment in time, wherein the coupling has been performed, according to some embodiments.

FIG. 1C illustrates the EBM and analog SoftMax gadget at a later moment in time, wherein the analog SoftMax gadget, coupled to the EBM, has thermodynamically evolved under an engineered potential of the analog SoftMax gadget such that the oscillators of the analog SoftMax gadget evolve to have values that encode a one-hot vector, which is the output of the SoftMax function when coupled with the output oscillators of the EBM, according to some embodiments.

FIG. 1D illustrates an example configuration wherein relay oscillators are used to provide an adjustable masses and/or frequencies that allow the output oscillators of the EBM to be treated as static when coupled with the analog SoftMax gadget, according to some embodiments.

FIG. 1E illustrates an additional example configuration wherein relay oscillators are used to provide adjustable masses and/or frequencies that allow the output oscillators of the EBM to be treated as static when coupled with the analog SoftMax gadget, and wherein additional relay gadgets are used to receive the result of the SoftMax function, implemented thermodynamically via the analog SoftMax gadget coupled to the EBM, wherein the additional relay gadgets store expectation values of the respective input/output oscillators of the analog SoftMax gadget, according to some embodiments.

FIG. 1F illustrates another example configuration wherein relay gadgets are used to receive the result of the SoftMax function, implemented thermodynamically via the analog SoftMax gadget coupled to the EBM, wherein the relay gadgets capture expectation values of the respective input/output oscillators of the analog SoftMax gadget, according to some embodiments.

FIG. 2 illustrates an example all-to-all coupling that may be used to couple input/output oscillators (ϕ_{b}_{ⱼ}) of the analog SoftMax gadget to one another, according to some embodiments.

FIG. 3 illustrates another example coupling, wherein additional oscillators (ϕₐ_{ⱼ}^{(l)}) are used to emulate an all-to-all coupling between input/output oscillators (ϕ_{b}_{ⱼ}) of the analog SoftMax gadget, wherein the input/output oscillators (ϕ_{b}_{ⱼ}) and the additional oscillators (ϕₐ_{ⱼ}^{(l)}) have a reduced degree of connectivity as compared to input/output oscillators (ϕ_{b}_{ⱼ}) used in an all-to-all coupling for a similar sized array of input/output oscillators, such as shown in FIG. 2, according to some embodiments.

FIG. 4 illustrates graphs of potentials for a given oscillator of the analog SoftMax gadget, wherein the given oscillator has a dual-well potential. FIG. 4 further illustrates how increasing the parameter A₁ in an engineered potential for the analog SoftMax gadget causes the walls and intermediate barrier between the two wells of the dual-well potential to be more steep, such that the dual-well oscillator is more likely to evolve to a value of 0 or 1 as required by the engineered potential for the analog SoftMax gadget, according to some embodiments.

FIG. 5 illustrates an example attention block of a machine learning model, that may be implemented in an analog manner using one or more thermodynamic chips, wherein an analog SoftMax gadget is used at least in part to implement the self-attention layer, according to some embodiments.

FIG. 6 is a flowchart illustrating a process for implementing a SoftMax function using an analog SoftMax gadget, according to some embodiments.

FIG. 7A illustrates additional details of a relay gadget implemented using a thermodynamic chip, wherein the relay gadget is configured to relay thermodynamic information between a first energy-based model (EBM) and a second energy-based model (EBM), such as an analog SoftMax gadget, according to some embodiments.

FIG. 7B is high-level diagram similar to FIG. 7A, wherein the relay gadget does not include a bias oscillator, according to some embodiments.

FIG. 8 is a high-level flowchart illustrating a process of relaying thermodynamic information between an output oscillator, such as of a first energy-based model (EBM), and an input oscillator, such as of an analog SoftMax gadget, according to some embodiments.

FIG. 9 is a high-level diagram illustrating an output oscillator, an input oscillator, and a relay gadget, wherein the relay gadget comprises a group of relay oscillators and is configured to relay expectation values of thermodynamic information between the output oscillator and the input oscillator, according to some embodiments.

FIG. 10 is a high-level diagram illustrating a spatial analogue relay gadget, wherein respective ones of relay oscillators of a group of relay oscillators are configured to store respective sample values of an output oscillator, according to some embodiments.

FIG. 11 is a high-level diagram illustrating a temporal analogue relay gadget, wherein a group of relay oscillators comprises a single relay oscillator, according to some embodiments.

FIG. 12 is a high-level diagram illustrating a series analogue relay gadget, wherein a group of relay oscillators comprises a plurality of relay oscillators arranged in series, according to some embodiments.

FIG. 13A illustrates example couplings between visible neurons of an energy-based model (EBM), according to some embodiments.

FIG. 13B illustrates example couplings between visible neurons and non-visible neurons (e.g., hidden neurons) of an energy-based model (EBM), according to some embodiments.

FIG. 14 is high-level diagram illustrating a process of determining weights and biases to be used in an energy-based model (EBM), wherein the weights and biases are determined using measurement values for synapse oscillators, according to some embodiments.

FIG. 15 is high-level diagram illustrating a process of determining weights and biases to be used in an energy-based model (EBM), wherein the weights and biases are computed using a classical computing device, according to some embodiments.

FIG. 16 is high-level diagram illustrating an example neuro-thermodynamic computer comprising a thermodynamic chip (e.g., that implements one or more energy-based models (EBMs), an analog SoftMax gadget, and a relay gadget) included in a dilution refrigerator and coupled to a classical computing device in an environment external to the dilution refrigerator, according to some embodiments.

FIG. 17 is high-level diagram illustrating an example neuro-thermodynamic computer comprising a thermodynamic chip (e.g., that implements one or more energy-based models (EBMs), an analog SoftMax gadget, and a relay gadget) included in a dilution refrigerator and coupled to a classical computing device that is also included in the dilution refrigerator, according to some embodiments.

FIG. 18 is high-level diagram illustrating an example neuro-thermodynamic computer comprising one or more thermodynamic chips (e.g., that implement one or more energy-based models (EBMs), an analog SoftMax gadget, and a relay gadget) coupled to a classical computing device in an environment other than a dilution refrigerator, according to some embodiments.

FIG. 19 is a high-level diagram illustrating oscillators included in a substrate of a thermodynamic chip and a mapping of the oscillators to logical neurons or synapses of the thermodynamic chip, according to some embodiments.

FIG. 20 is an additional high-level diagram illustrating oscillators included in a substrate of a thermodynamic chip mapped to logical neurons, weights, and biases (e.g., synapses) of a neuro-thermodynamic computing system, according to some embodiments.

FIG. 21 is a block diagram illustrating an example computer system that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

### DETAILED DESCRIPTION

The present disclosure relates to methods, systems, and an apparatus for performing computer operations using a thermodynamic chip and more specifically to an analog implementation of a SoftMax function, such as using components of a neuro-thermodynamic computing device, wherein inputs and outputs of the SoftMax function are represented in a thermodynamic state and wherein the SoftMax function is performed while maintaining the information in the thermodynamic state (e.g. analog state).

In some embodiments, a SoftMax function is implemented by configuring oscillators of a thermodynamic chip according to an engineered potential that implements the SoftMax function. The oscillators configured with the engineered potential may be referred to herein as an analog SoftMax gadget. The analog SoftMax gadget is configured to be coupled to oscillators, such as output oscillators of another energy-based model (e.g. another EMB) or relay oscillators (or other oscillators) coupled to output oscillators of another EBM. The output oscillators of the other EBM may evolve under the influence of the engineered potential of the analog SoftMax gadget such that, once thermal equilibrium is reached (while the analog SoftMax gadget is coupled to the output oscillators of the other EBM), the input/output oscillators of the analog SoftMax gadget represent the SoftMax function evaluated at the output of the other EBM. Also, relay oscillators may be used to relay thermodynamic information (e.g., that is the output of another energy-based model) as input thermodynamic information that is to be processed by the analog SoftMax gadget. For example, relay oscillators may be used to hold the position degree of freedom values of the output oscillators of the other EBM to be approximately static during the thermal evolution of the analog SoftMax gadget.

Due to the engineered potential of the analog SoftMax gadget, the input/output oscillators (having position degrees of freedom ϕ_{b}_{ⱼ}) of the analog SoftMax gadget thermodynamically evolve to a one-hot encoded vector (e.g. the output of the SoftMax function) when coupled with oscillators of another EBM (e.g. either directly or via respective relay oscillators). Also, a relay gadget (comprising a group of relay oscillators) may be used to capture and store an expectation value of a given one of the input/output oscillators of the analog SoftMax gadget. Note that the output of the SoftMax gadget is a one-hot encoded vector, but the expectation values of a given member of the one-hot encoded vector (e.g. an expectation value of a given input/output oscillator of the analog SoftMax function) may represent a SoftMax result for that given vector position. For example, at thermal equilibrium the respective input/output oscillators of the analog SoftMax gadget may oscillate such that any one of the respective input/output oscillators of the analog SoftMax gadget could be the “one-hot” oscillator at a given moment in time with some probability. The captured expectation value may be used to represent such a probability for a given vector position. This may be referred to a SoftMax value for a given vector position of a vector input to the SoftMax function.

Once the analog SoftMax gadget has thermodynamically evolved to the one-hot encoded vector state for the input/output oscillators (ϕ_{b}_{ⱼ}) (e.g., reached thermal equilibrium), this output (e.g. the one hot encoded vector) may be provided to other EBMs as an input. Also, SoftMax values for each input/output oscillator (e.g. measured expectation values) may be stored in relay gadget and provided as inputs to one or more additional EBMs. For example, in some embodiments, an attention block of a machine learning model may be implemented in a fully analog manner using thermodynamic chips. In such embodiments, one or more energy-based models (EBMs) may be used to implement input embedding, wherein outputs of these energy-based models (EBMs) that perform input embedding are relayed as inputs to an analog SoftMax gadget. Additionally, an output of the analog SoftMax gadget (e.g. a one hot encoded vector) may be provided via coupling as an input to one or more other energy-based models (EBMs) that implement a self-attention layer. However, it should be noted that a SoftMax function may be used in various applications and the analog SoftMax gadget described herein may be used to provide an analog implementation of the SoftMax function using thermodynamic chips in any of the various applications in which a SoftMax function may be used.

As used herein, a one-hot encoded vector refers to a vector output of the SoftMax function wherein all values of the vector are zeros or a one, and wherein only one value is a one. For example, in response to receiving a three-dimensional vector input, a one hot encoded vector output of length three may be (0,0,1), (0,1,0), or (1,0,0). Similarly for any input vector of dimension N, a one hot encoded vector returned will have the same dimension (N) where all values are zero other than one value which is a one.

The analog SoftMax gadget is constructed using input/output oscillators (having position degree of freedom ϕ_{b}_{ⱼ}) and optionally additional oscillators (having position degree of freedom ϕₐ_{ⱼ}^{(l)}), that are configured to have an energetic penalty if the input/output oscillators position degree of freedom (ϕ_{b}_{ⱼ}) do not evolve to a value of one or zero. The couplings between such oscillators adds an additional energetic penalty if the oscillators do not evolve to a one-hot encoded vector. Note that the subscript j is used to indicate that there may be any number of input/output oscillators used depending on the size (N) of the input vector for which the SoftMax function result is being determined. Also, note that the superscript (l) is used to indicate a layer to which the additional oscillators belong in embodiments that use a modified tree structure to emulate all-to-all coupling between the input/output oscillators (ϕ_{b}_{ⱼ}). For example, the input/output oscillators (having position degree of freedom ϕ_{b}_{ⱼ}) may be dual-well oscillators with respective potentials that have well minima at zero and one. Thus, thermodynamically they are driven to evolve their position degree of freedom to a value of zero or one. Additionally, an all-to-all coupling between the input/output oscillators position degree of freedom (ϕ_{b}_{ⱼ}) (or a tree-like coupling emulating an all-to-all coupling using the additional oscillators (having position degree of freedom ϕₐ_{ⱼ}^{(l)}) is used such that there is an energetic penalty if the sum of all the input/output oscillators position degrees of freedom (sum of ϕ_{b}_{ⱼ}) is a value other than one. These two aspects of the engineered potential are discussed in more detail below and cause the analog SoftMax gadget to evolve to a one-hot encoded vector regardless of the values of the input thermodynamic information that is provided to the analog SoftMax gadget as inputs via couplings with output oscillators of another EBM.

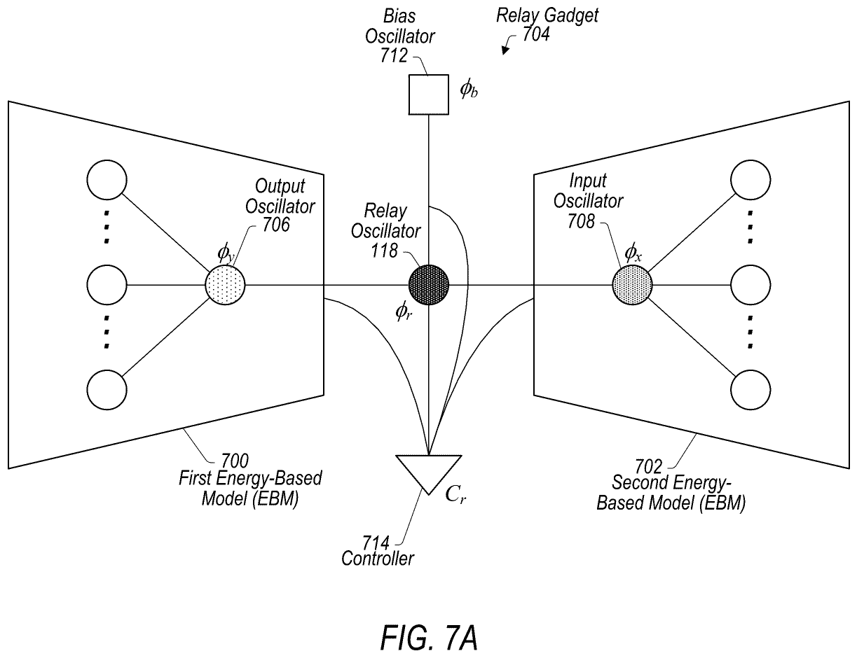

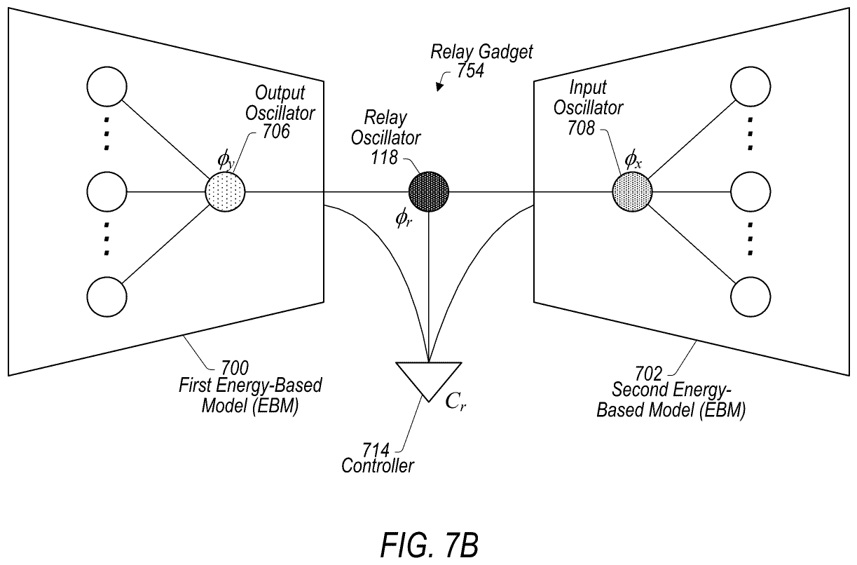

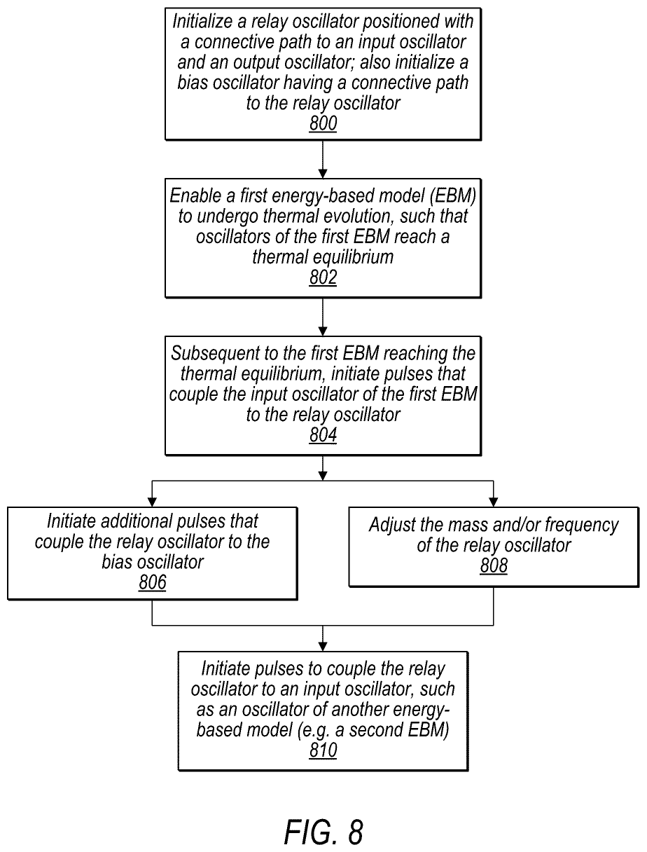

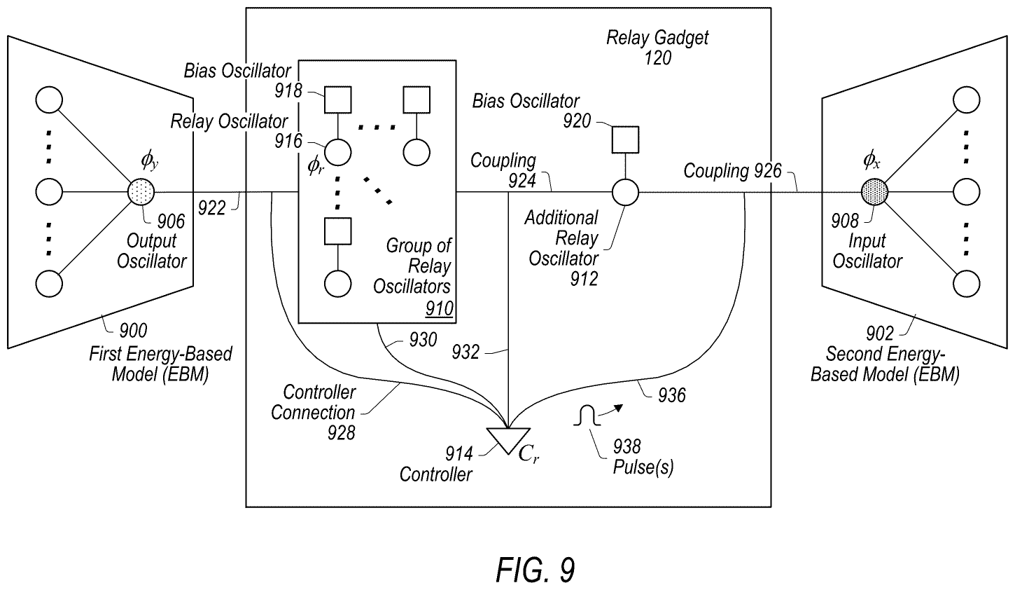

In some embodiments, relay oscillators may be used to provide inputs to the analog SoftMax gadget. Also, other relay oscillators (or groups of relay oscillators that form a relay gadget) may be used to store and/or relay results of the application of the analog SoftMax gadget to output oscillators of another EBM. For example, sample values of the input/output oscillators of the analog SoftMax gadget may be relayed using respective relay oscillators, for example as discussed with regard to FIGS. 7-8. Also, as further discussed below with regard to FIGS. 9-12 groups of relay oscillators may be used to form relay gadgets that capture and store expectation values for respective ones of the input-output oscillators of the analog SoftMax gadget. These expectation values may then be provided as inputs to other EBMs.

Relay oscillators communicate thermodynamic information in an analog manner This can be contrasted with other approaches to communicate information that involve reading out thermodynamic information, such as using a classical computing device, and then relaying the information in classical form. For example, the ability to relay thermodynamic information directly between components in a neuro-thermodynamic computer avoids issues associated with readout to a classical computing device, such as read-out error, loss of information, and/or delays associated with performing readout. Moreover, if the information is to be used by another component of a neuro-thermodynamic computing device, relay of the information in a thermodynamic state avoids other delays such as would be incurred if required to initialize a receiving component to have an initial state corresponding to a state of the thermodynamic information that was read out from another component, wherein the relayed information is not already in a thermodynamic state. In some embodiments, such relay techniques as described herein may be used to relay thermodynamic information between energy-based models (EBMs). Such energy-based models (EBMs) may include trained models that evolve according to Langevin dynamics, and which may be used to generate inferences, such as machine learning (ML) inferences. For example, an ML model used to generate an ML inference may be physically implemented as a trained energy-based model (EBM). An analog SoftMax gadget as described herein may be one such EBM, configured with an engineered potential that implements the SoftMax function.

Multiple types of computations, such as inference and Gibbs sampling can be greatly accelerated when implemented on a thermodynamic processor, where the individual components of such models are oscillators implemented on superconducting circuit elements. However, in many applications, the desired operations need to be performed on circuits with multiple components (with each component performing a particular computation), which can add significant constraints on the selection of parameters for each of the oscillator of the thermodynamic chip. For example, if frequency or mass differentials (or combinations of both) between oscillators are used to cause thermodynamic information flow to move analog information between components in a desired manner, there are a limited number of easily achievable frequency and mass combinations of oscillators. Thus, the complexity of such systems quickly becomes self-limiting due to the inability to achieve thermodynamic information flow when primarily relying on mass and/or frequency differentials between oscillators to guide information flow. For example, in order to achieve thermodynamic information flow, it may be necessary that a value of mass times frequency squared of a sending oscillator is much greater than a corresponding value of mass times frequency squared of a receiving oscillator. As such, having the ability to modularize large circuits, with each modular component responsible for a particular task, such as performing SoftMax operations, is needed for implementing such models using thermodynamic processors. In such a modularized approach, mass and/or frequency differentials can be used within a given model, but a relay gadget can be used to relay information between modules, without a need to consider oscillator parameters of a given module when selecting oscillator parameters of another module. This modularization greatly simplifies the selection of oscillator parameters.

As described herein, a relay gadget provides a solution to controlling thermal information flow without having to rely on varying mass and frequency combinations between components to drive the thermodynamic information flow. For example, a relay gadget includes a relay oscillator that has a controllably adjustable mass and/or frequency that can be used to couple to oscillators belonging to other modules. This allows controlled thermodynamic information flow without having to worry about relative mass and/or frequency sizing between oscillators of the components (e.g., such as oscillators of an input EBM and oscillators of a destination EBM). For example, using a relay oscillator reduces the required constraints on the selection of parameters for oscillators belonging to different modules. The relay oscillator can also be used to obtain samples from various degrees of freedom of an oscillator. Such samples can be used to do Gibbs sampling.

In some embodiments, the input/output oscillators (ϕ_{b}_{ⱼ}) of the analog SoftMax gadget may be configured with adjustable mass and/or frequency similar to a relay oscillator (e.g. in some embodiments relay oscillators may be used as the input/output oscillators (ϕ_{b}_{ⱼ})).

In some embodiments, a second oscillator may optionally be included in a relay gadget with the relay oscillator, wherein the second oscillator acts as a bias (e.g., bias oscillator). The bias oscillator may be used to enable the relay oscillator to maintain its equilibrium value for longer time scales as the coupling between the relay oscillator and output oscillator from one of the modules is turned off. Also, in some embodiments, the relay oscillator has a time dependent mass and constant frequency, and in other embodiments the relay oscillator has a constant mass but time-dependent frequency.

In some embodiments, a neuro-thermodynamic processor may be configured such that learning algorithms for learning parameters of an energy-based model may be applied using Langevin dynamics. For example, as described herein, a thermodynamic chip of a neuro-thermodynamic processor may be configured such that, given a Hamiltonian that describes an energy-based model, weights and biases (e.g., synapses) may be calculated based on measurements taken from the thermodynamic chip as it naturally evolves according to Langevin dynamics. For example, a positive phase term, a negative phase term, and associated gradients needed to determine updated weights and biases for the energy-based model may be simply computed on an accompanying classical computing device, such as a field programmable gate array (FPGA) or application specific integrated circuit (ASIC), based on measurements taken from the oscillators of the thermodynamic chip. Such calculations performed on the accompanying classical computing device may be simple and non-complex as compared to other approaches that use the classical computing device to determine statistical probabilities (e.g., without using a thermodynamic chip). Also, in some embodiments, weights and biases used in an energy-based model may be determined iteratively, for example wherein a classical computing device is used to generate updated weights and biases, and wherein resulting inference performance is compared to training data to determine whether additional iterative learning is needed. In some embodiments, a sequence of additional relay oscillators may be used to store measurements of synapse oscillators and may further be used to determine update synapse values in an analog training scheme.

In some embodiments, physical elements of a thermodynamic chip may be used to physically model evolution according to Langevin dynamics. For example, in some embodiments, a thermodynamic chip includes a substrate comprising oscillators implemented using superconducting flux elements. The oscillators may be mapped to neurons (visible or hidden) that “evolve” according to Langevin dynamics. For example, the oscillators of the thermodynamic chip may be initialized in a particular configuration and allowed to thermodynamically evolve. As the oscillators “evolve” degrees of freedom of the oscillators may be sampled. Values of these sampled degrees of freedom may represent, for example, vector values for neurons or synapses that evolve according to Langevin dynamics. For example, algorithms that use stochastic gradient optimization and require sampling during training, such as those proposed by Welling and Teh, and/or other algorithms, such as natural gradient descent, mirror descent, etc. may be implemented using a thermodynamic chip. In some embodiments, a thermodynamic chip may enable such algorithms to be implemented directly by sampling the neurons and/or synapses (e.g., degrees of freedom of the oscillators of the substrate of the thermodynamic chip) without having to calculate statistics to determine probabilities. As another example, thermodynamic chips may be used to perform autocomplete tasks, such as those that use Hopfield networks, for example, an analog SoftMax gadget may be implemented as an EBM with oscillators configured in a Hopfield network arrangement.

In some embodiments, a thermodynamic chip includes superconducting flux elements arranged in a substrate, wherein the thermodynamic chip is configured to modify magnetic fields that couple respective ones of the oscillators with other ones of the oscillators. In some embodiments, non-linear (e.g., anharmonic) oscillators are used that have dual-well potentials. These dual-well oscillators may be mapped to neurons of a given energy-based model that the thermodynamic chip is being used to implement, such as an analog SoftMax gadget. In some embodiments, oscillators may be implemented using superconducting flux elements with varying amounts of non-linearity. In some embodiments, an oscillator may have a single well potential, a dual-well potential, or a potential somewhere in a range between a single-well potential and a dual-well potential. In some embodiments, visible neurons may be mapped to oscillators having a single well potential, a dual-well potential, or a potential somewhere in a range between a single-well potential and a dual-well potential.

In some embodiments, oscillators of a thermodynamic chip may also be used to represent values of weights and biases of the energy-based model. Thus, weights and biases that describe relationships between neurons may also be represented as dynamical degrees of freedom, e.g., using oscillators of the thermodynamic chip (e.g., synapse oscillators).

In some embodiments, parameters of an energy-based model or other learning algorithm may be learned through evolution of the oscillators of a thermodynamic chip.

As mentioned above, in some embodiments, the weights and biases of an energy-based model may be dynamical degrees of freedom (e.g., oscillators of a thermodynamic chip), in addition to neurons (hidden or visible) being dynamic degrees of freedom (e.g., represented by other oscillators of the thermodynamic chip). In such configurations, gradients needed for learning algorithms can be obtained by performing sampling of the synapse oscillators, such as position samples or momentum samples. For example, measurements of the synapse oscillators (position or momentum) performed on a time scale proportional to a thermalization time of the synapse oscillators, or on shorter time scales than the thermalization times of the synapse oscillators, can be used to compute time-averaged gradients in addition to space averaged gradients. In some embodiments, the variance of the time averaged or space averaged gradient (determined using synapse oscillator measurements) scales as 1/t where t is the total measurement time. These gradients can be used to calculate new weights and bias values that may be used as synapse values in an updated version of the energy-based model. The process of making measurements and determining updated weights and biases may be repeated multiple times until a learning threshold for the energy-based model has been reached.

For example, let the input to the analog SoftMax gadget be given by ηⱼ, where the vector has dimension N, such that j is from 1 to N. This then gives softmax

$$( {η}_{j} ) = \frac{{e}^{{η}_{j}}}{{\sum }_{i = 1}^{K} {e}^{{η}_{i}}} .$$

Also, assume the engineered potential can be formulated as a function of the input/output oscillators' position degree of freedom (ϕ_{b}_{ⱼ}) (for the input/output oscillators of the analog SoftMax gadget) and the output oscillators' position degree of freedom (ϕₙ_{ⱼ}) of output oscillators of another EBM that is being coupled to the analog SoftMax gadget in order to perform the SoftMax function. The coupling term in the potential of the analog SoftMax gadget is then given by Vₛ=λₛΣⱼ₌₁^{N}ϕ_{b}_{ⱼ}ϕ_{η}_{ⱼ}, where the vector of oscillators ϕ_{b}∈ [symbol] ^{N} is a vector of oscillators that is constrained to be an element of the standard basis of [symbol] ^{N}. For instance, if N=3, then the possible vector values for the three input/output oscillators of the analog SoftMax gadget are ϕ_{b}_{₁}=(1,0,0); ϕ_{b}_{₂}=(0,1,0); and ϕ_{b}_{₃}=(0,0,1). As such, the input/output oscillators of the analog SoftMax gadget can be thought of as being coupled in a way such that the vector ϕ_{b} is constrained to take on values of the standard basis for [symbol] ^{N}. Due to the respective masses and frequencies of the output oscillators (or relay oscillators) (ϕ_{η}_{ⱼ}) with which the input/output oscillators are coupled having a much larger product of mass times frequency squared than those of the input/output oscillators of the analog SoftMax gadget, the output oscillators (or relay oscillators) (ϕ_{η}_{ⱼ}), with which the input/output oscillators are coupled, may be considered to have static position degrees of freedom. For example, in embodiments in which relay oscillators are used to provide the input thermodynamic information to the analog SoftMax gadget, the mass and/or frequency of the relay oscillators may be adjusted to ensure they are much larger than those of the input/output oscillators of the analog SoftMax gadget.

Using the Gibbs state, the expectation value of the position degree of freedom of the jth input/output oscillator of the analog SoftMax gadget (while being coupled to the output oscillators (or relay oscillators) (ϕ_{η}_{ⱼ}), is given by:

$$\begin{matrix}〈 {ϕ}_{{b}_{j}} 〉 = {\sum }_{b} {ϕ}_{{b}_{j}} \frac{{e}^{- β {V}_{s} ( {ϕ}_{b} )}}{{\sum }_{{b}^{′}} {e}^{- β {V}_{s} ( {ϕ}_{{b}^{′}} )}} \\ = \frac{{e}^{- {βλ}_{s} ( {ϕη}_{j} )}}{{\sum }_{i = 1}^{N} {e}^{- {βλ}_{s} ( {ϕη}_{i} )}}\end{matrix}$$

The above equation takes advantage of the fact that in the ϕ_{b} vectors, only one of the input/output oscillators ϕ_{b}_{ⱼ} can be 1, and all others are zero. Also, by choosing the coupling strength between the input/output oscillators of the analog SoftMax gadget and the oscillators with which they couple to provide information to be such that λₛ=−1/β, the average of the j'th component of the output vector is the desired SoftMax function result. Note that λₛ is the coupling strength, wherein β=1/K_{B}T, where K_{B} is the Boltzmann constant and T is temperature in Kelvin.

More particularly, to achieve this result an engineered potential is selected for the oscillators and couplings of the analog SoftMax gadget as further described below. In particular, whenever an element of the output vector is one (such as ϕ_{b}_{ⱼ}=1) then all other elements (e.g. input/output oscillators) must take the value of zero. An engineered potential which implements the SoftMax function (and therefore achieves this result) is given by:

$$V ( {ϕ}_{{b}_{1}} , … , {ϕ}_{{b}_{N}} ) = {A}_{1} {\sum }_{j = 1}^{N} {{ϕ}_{{b}_{j}}^{2} ( {ϕ}_{{b}_{j}} - 1 )}^{2} + {{A}_{2} ( {\sum }_{j = 1}^{N} {ϕ}_{{b}_{j}} - 1 )}^{2}$$

Note that in the above potential, the first term (before the plus sign) converges to one or zero. For example, if ϕ_{b}_{ⱼ} is 1, then 1−1=0 and the term converges to a minima, e.g. a well minima of a dual well oscillator. Conversely, if ϕ_{b}_{ⱼ} is 0, then zero squared is zero and the term converges to a minima, e.g. the other well minima of a dual well oscillator. Also, note that the second term ensures the sum of the input/output oscillators converge to 1, this is because 1−1=0, such that there is an energy penalty if the sum does not converge to 1.

Now incorporating the coupling terms from above (Vₛ=λₛΣⱼ₌₁^{N}ϕ_{b}_{ⱼ}ϕ_{η}_{ⱼ}) with the potentials just discussed that drive the input/output oscillators to zero or one and a sum of one, at thermal equilibrium, the expectation value for a given input/output oscillator [symbol] ϕ_{b}_{ⱼ} [symbol] is given by:

$$\begin{matrix}{〈 {ϕ}_{{b}_{j}} 〉}_{thermal equilibrium} = \frac{\int {dbϕ}_{{b}_{j}} {e}^{- β V ( {ϕ}_{b} )} {e}^{- β {V}_{s} ( {ϕ}_{b} )}}{\int {db}^{′} {e}^{- β V ( {ϕ}_{{b}^{′}} )} {e}^{- β {V}_{s} ( {ϕ}_{{b}^{′}} )}} \\ \approx \frac{{e}^{- β V ( {e}_{j} )} {e}^{- β {V}_{s} ( {e}_{j} )}}{{\sum }_{i = 1}^{N} {e}^{- β V ( {e}_{i} )} {e}^{- β {V}_{s} ( {e}_{i} )}} \\ = \frac{{e}^{- β {V}_{s} ( {e}_{j} )}}{{\sum }_{i = 1}^{N} {e}^{- β {V}_{s} ( {e}_{i} )}}\end{matrix}$$

where eⱼ is used to denote the j'th standard basis vector of [symbol] ^{N}. Going from the first line in the above equation to the second line takes advantage of the fact that e^{-βV(ϕ}^{_{b}}⁾ is approximately non-zero only for values of ϕ_{b}_{ⱼ} which are elements of the standard basis vector of [symbol] ^{N}. Furthermore, since the exponential is multiplied by ϕ_{b}_{ⱼ}, the resulting integral will be non-zero only when ϕ_{b}_{ⱼ}=eⱼ. Also, in going from the second line to the third line, the symmetry of the potential (V(ϕ_{b}_{₁}, . . . , ϕ_{b}_{_{N}})=A₁Σⱼ₌₁^{N}ϕ_{b}_{ⱼ}²(ϕ_{b}_{ⱼ}−1)²+A₂(Σⱼ₌₁^{N}ϕ_{b}_{ⱼ}−1)²) is exploited which ensures that e^{-βV(e}^{ⱼ}⁾=e^{-BV(e}^{ⱼ}⁾ for all i, j∈{1, . . . , N}. As such, the e^{-βV(e}^{ⱼ}⁾ in the numerator cancels with the exponential terms in the denominator of the form e^{-βV(e}^{ᵢ}⁾.

In the above, the oscillators that couple with the input/output oscillators (e.g., the ϕ_{η}_{ⱼ} oscillators) are treated as constants. However, below is a more careful treatment that accounts for variation in the ϕ_{η}_{ⱼ} oscillators.

$$\begin{matrix}{〈 {ϕ}_{{b}_{j}} 〉}_{thermal equilibrium} = \frac{\int d {ϕ}_{η} d {ϕ}_{b} {ϕ}_{{b}_{j}} {e}^{- β V ( {ϕ}_{b} )} {e}^{- β {V}_{s} ( {ϕ}_{b} )} {e}^{- β {V}_{η}}}{\int d {ϕ}_{η} d {ϕ}_{b} {e}^{- β V ( {ϕ}_{{b}^{′}} )} {e}^{- β {V}_{s} ( {ϕ}_{{b}^{′}} )} {e}^{- β {V}_{η}}} \\ \approx \frac{{e}^{\frac{{( {η}_{j} - β m {ωλ}_{s} )}^{2}}{2 β {m}^{3} {ω}^{3}}} {\prod }_{i \neq j} \frac{{η}_{i}^{2}}{{e}^{2 β {m}^{3} {ω}^{3}}}}{{\sum }_{i = 1}^{N} {e}^{\frac{{( {η}_{i} - β m {ωλ}_{s} )}^{2}}{2 β {m}^{3} {ω}^{3}}} {\prod }_{k \neq i} \frac{{η}_{k}^{2}}{{e}^{2 β {m}^{3} {ω}^{3}}}} \\ = \frac{{e}^{\frac{{η}_{j}^{2}}{2 β {m}^{3} {ω}^{3}} - \frac{{λ}_{s} {η}_{j}}{{m}^{2} {ω}^{2}}} {\prod }_{i \neq j} \frac{{η}_{i}^{2}}{{e}^{2 β {m}^{3} {ω}^{3}}}}{{\sum }_{i = 1}^{N} {e}^{\frac{{η}_{i}^{2}}{2 β {m}^{3} {ω}^{3}} - \frac{{λ}_{s} {η}_{i}}{{m}^{2} {ω}^{2}}} {\prod }_{k \neq i} \frac{{η}_{k}^{2}}{{e}^{2 β {m}^{3} {ω}^{3}}}}\end{matrix}$$

wherein in the above equations, if λₛ=m²ω² is set and along with the condition that

$$\frac{{η}_{j}^{2}}{2 β {m}^{3} {ω}^{3}} ≪ 1$$

for all j∈{1, . . . , N}, then the equation simplifies to

$${〈 {ϕ}_{{b}_{j}} 〉}_{thermal equilibrium} = \frac{{e}^{{η}_{j}}}{{\sum }_{i = 1}^{N} {e}^{{η}_{i}}}$$

which equals the SoftMax function of the inputs to the analog SoftMax gadget, e.g., =SoftMax (ηⱼ). Note that V_{η} is the potential of the input to the analog SoftMax gadget, for example which may be represented as output oscillators of another EBM. Generally speaking V_{η} is the potential that results in the output oscillators of the other EBM (or relay oscillators, if relay oscillators are providing the input to the analog SoftMax gadget) having a thermal equilibrium value such that the oscillators of the other EBM have values ηⱼ. As a specific example in which the analog SoftMax gadget is used in an attention layer of a transformer, the potential V_{η} is given by:

$${V}_{η} = \frac{1}{2} {m}_{η} {ω}_{η}^{2} {ϕ}_{{η}_{j}}^{2} + \frac{1}{2} {m}_{r} {ω}_{r}^{2} {\sum }_{i = 1}^{D} {( {ϕ}_{{r}_{i}} - {q}_{i} {k}_{{j}_{i}} )}^{2} - {λ}_{d} {\sum }_{i = 1}^{D} {ϕ}_{{η}_{j}} {ϕ}_{{r}_{i}} ,$$

where q and k are a query vector and a key vector for the transformer, where D is the internal size of the attention operation of the transformer, and wherein or are a set of relay oscillators used in determining values for ϕ_{η}_{ⱼ} by performing a dot product between ϕ_{q}_{ᵢ} oscillators and ϕₖ_{ⱼ} oscillators.

Also, in some embodiments, the ηⱼ oscillators may be relay oscillators with adjustable mass and/or frequency. This further allows the constraint

$$\frac{{η}_{j}^{2}}{2 β {m}^{3} {ω}^{3}} ≪ 1$$

to be satisfied.

Broadly speaking, classes of algorithms that may benefit from implementation using a thermodynamic chip include those algorithms that involve probabilistic inference. Such probabilistic inferences (which otherwise would be performed using a CPU or GPU) may instead be delegated to the thermodynamic chip for a faster and more energy efficient implementation. At a physical level, the thermodynamic chip harnesses electron fluctuations in superconductors coupled in flux loops to model Langevin dynamics. In some embodiments, architectures such as those described herein may resemble a partial self-learning architecture, wherein classical computing device(s) (e.g., a FPGA, ASIC, etc.) may be relied upon only to perform simple tasks such as summing measured values and performing other non-compute intensive operations in order to implement a learning algorithm.

Note that in some embodiments, electro-magnetic or mechanical (or other suitable) oscillators may be used. A thermodynamic chip may implement neuro-thermodynamic computing and therefore may be said to be neuromorphic. For example, the neurons implemented using the oscillators of the thermodynamic chip may function as neurons of a neural network that has been implemented directly in hardware. Also, the thermodynamic chip is “thermodynamic” because the chip may be operated in the thermodynamic regime slightly above 0 Kelvin, wherein thermodynamic effects cannot be ignored. For example, some thermodynamic chips may be operated within the milli-Kelvin range, and/or at 2, 3, 4, etc. degrees Kelvin. The term thermodynamic chip also indicates that the thermal equilibrium dynamics of the neurons are used to perform computations. In some embodiments, temperatures less than 15 Kelvin may be used. Though other temperatures ranges are also contemplated. This also, in some contexts, may be referred to as analog stochastic computing. In some embodiments, the temperature regime and/or oscillation frequencies used to implement the thermodynamic chip may be engineered to achieve certain statistical results. For example, the temperature, friction (e.g., damping) and/or oscillation frequency as well as masses, may be controlled variables that ensure the oscillators evolve according to a given dynamical model, such as Langevin dynamics. In some embodiments, temperature may be adjusted to control a level of noise introduced into the evolution of the neurons. As yet another example, a thermodynamic chip may be used to model energy models that require a Boltzmann distribution. Also, a thermodynamic chip may be used to solve variational algorithms and perform learning tasks and operations.

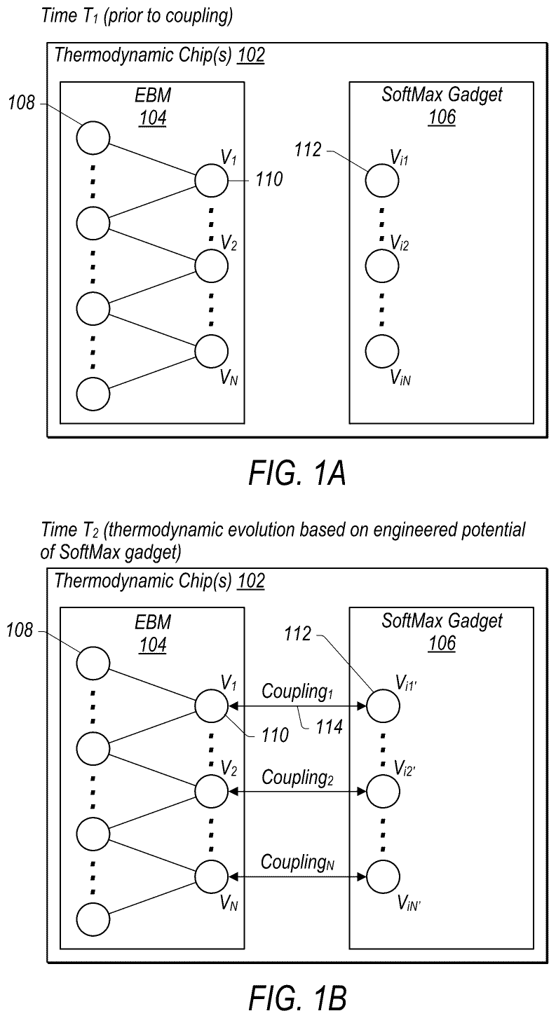

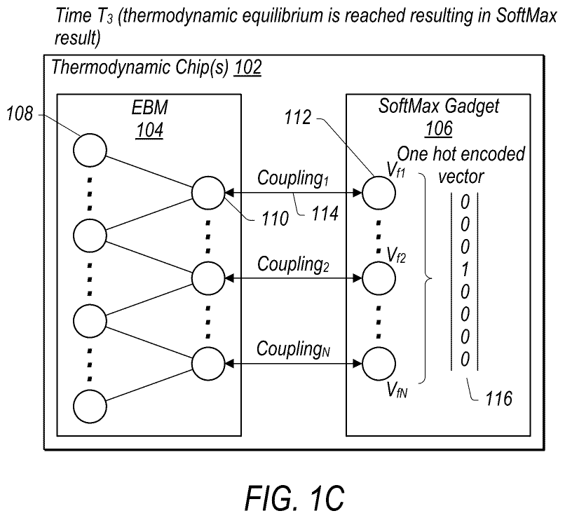

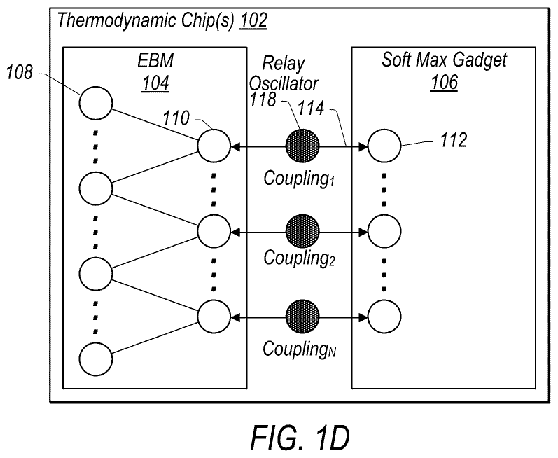

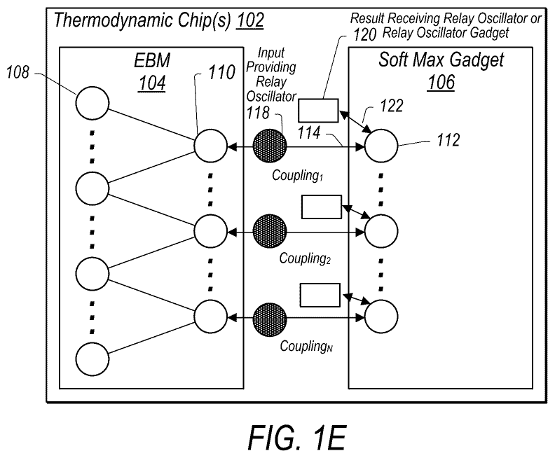

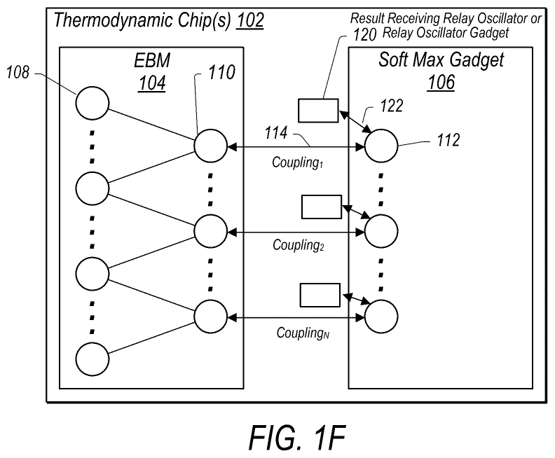

FIG. 1A is high-level diagram illustrating an energy-based model (EBM) implemented using a thermodynamic chip and an analog SoftMax gadget implemented using a thermodynamic chip, wherein the EBM and analog SoftMax gadget are shown at a first moment in time (e.g. prior to a coupling between oscillators of the SoftMax gadget and oscillators of the EBM, wherein the coupling (performed directly or via relay oscillators) provides input values for a SoftMax function that is performed thermodynamically), according to some embodiments.

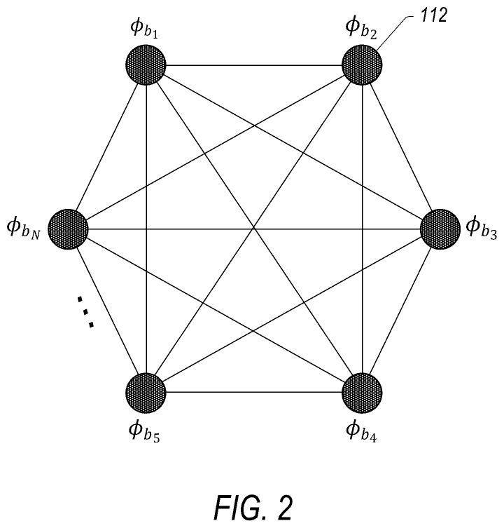

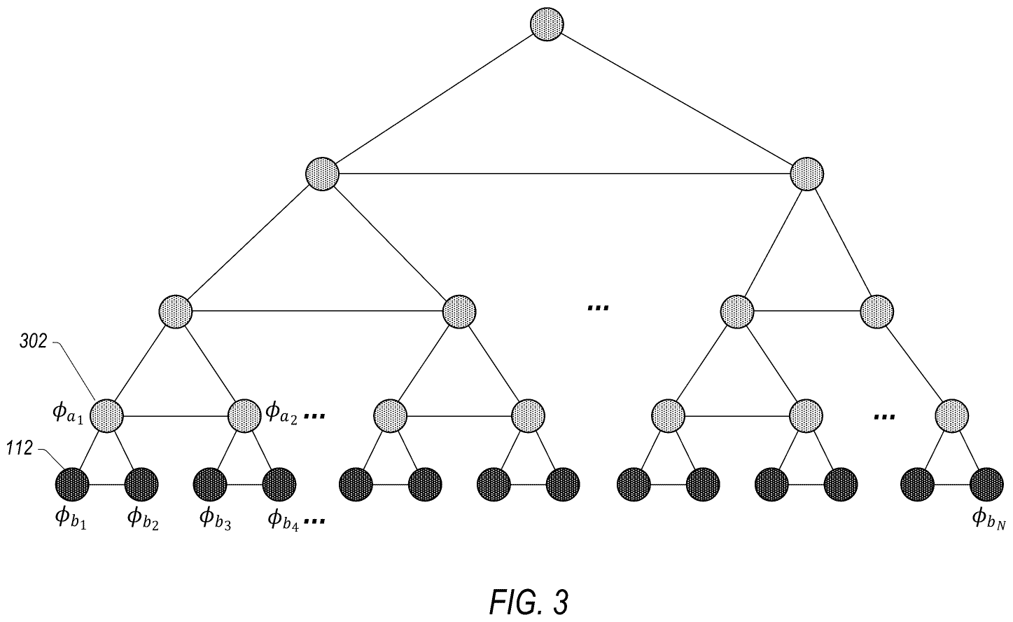

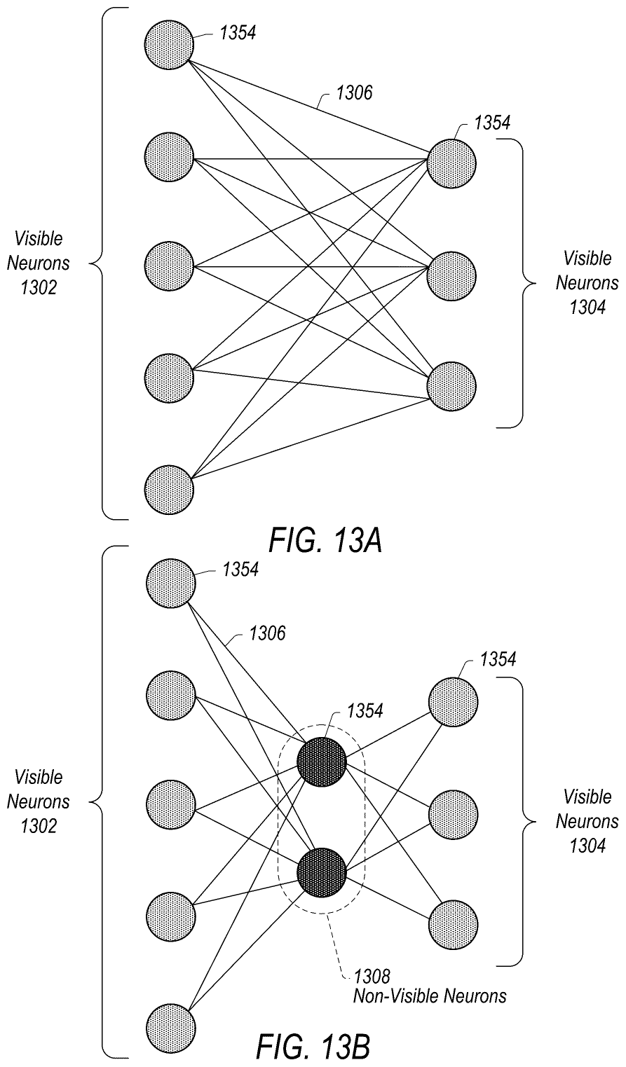

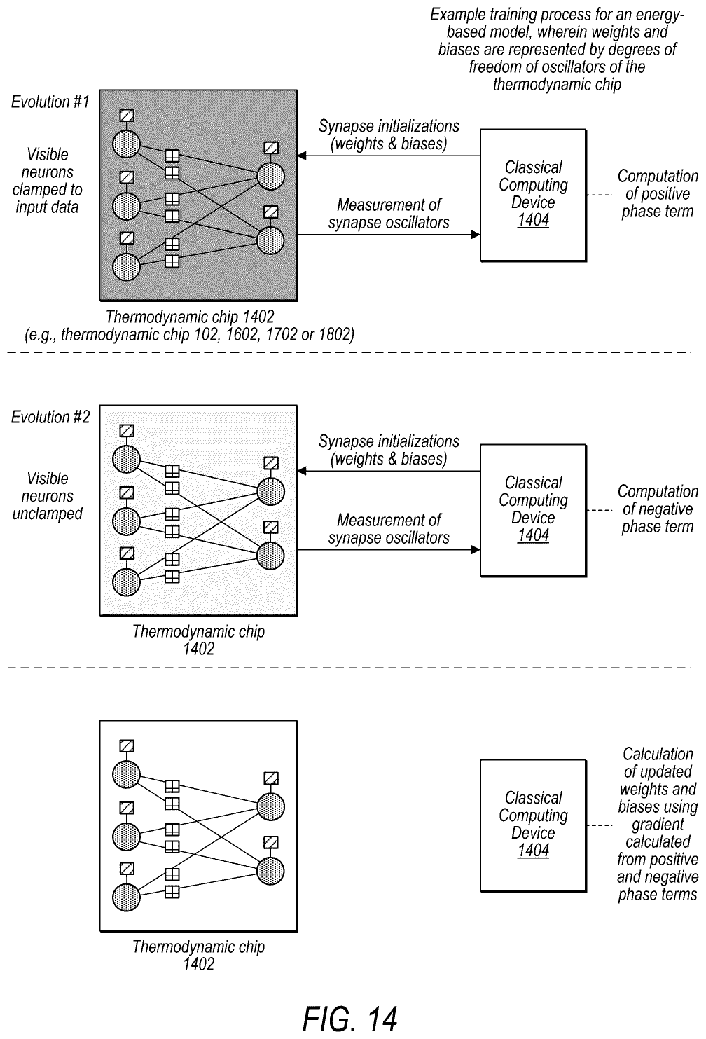

Thermodynamic chips 102, which may be a single thermodynamic chip or a set of connected thermodynamic chips, include oscillators that implement an energy-based model and an analog SoftMax gadget. For example, thermodynamic chip 102 implements energy-based model 104 that includes input oscillators 108 and output oscillators 110. There may also be hidden neurons (e.g., oscillators coupled to both the inputs and outputs, and which are coupled amongst each other) as shown in FIG. 13B. Also, thermodynamic chip 102 implements analog SoftMax gadget 106 that includes input/output oscillators 112 (and may optionally include additional oscillators 302, as shown in FIG. 3). Note that for case of explanation the couplings between input/output oscillators 112 of analog SoftMax gadget 106 are not shown in FIGS. 1A-IF, but it should be understood that the input/output oscillators 112 may be configured in an all-to-all coupling arrangement as shown in FIG. 2, or additional oscillators 302 may be used to emulate an all-to-all coupling using a modified tree structure, as shown in FIG. 3. While not shown, in some embodiments, energy-based model 104 may include additional oscillators, such as non-visible neurons 1308 as shown in FIG. 13B. Also, energy-based model 104 may include synapse oscillators (e.g. weights and bias oscillators), such as shown in FIGS. 14, 15, and 20.

The input/output oscillators 112 of analog SoftMax gadget 106 are configured, and initialized, in accordance with the engineered potential described above that ensures the input/output oscillators 112 are dual well oscillators with well minima at zero and one, and further that the input/output oscillators 112 are coupled in a configuration that ensures the overall sum of the input/output oscillators 112 has an energy penalty for values that do not sum to one. This may be achieved by adjusting the A₁ and A₂ terms in the engineered potential V(ϕ_{b}_{₁}, . . . ϕ_{b}_{_{N}})=A₁Σⱼ₌₁^{N}ϕ_{b}_{ⱼ}²(ϕ_{b}_{ⱼ}−1)²+A₂(Σⱼ₌₁^{N}ϕ_{b}_{ⱼ}−1)².

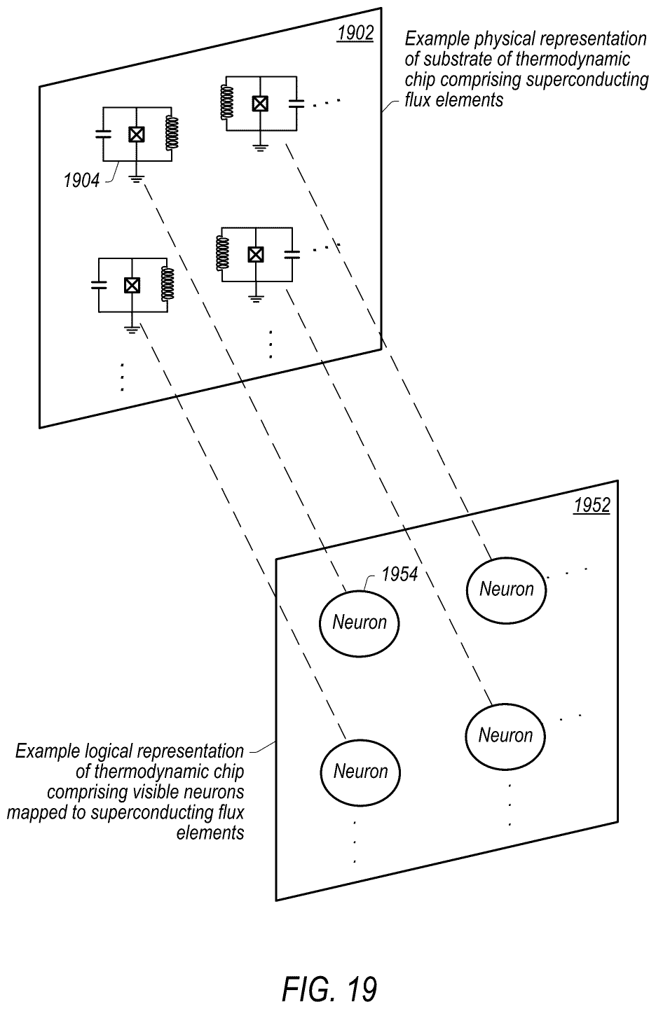

For example, inductor parameters, Josephson junction parameters, and capacitance parameters of the respective inductors, Josephson junctions and capacitors used to implement the respective input/output oscillators may be adjusted. For example, additional details regarding the components used to implement a respective oscillator, such as a respective input/output oscillator 112 the analog SoftMax gadget 106 are further discussed in FIG. 19. Also, the coupling strength between the input/output oscillators may be given by λₛ=−1/β, wherein β=1/K_{B}T, where K_{B} is the Boltzmann constant and T is temperature in Kelvin.

The energy-based model 104 may thermodynamically evolve at time T₁ prior to being coupled to analog SoftMax gadget 106. For example, input data may be provided to energy-based model 104 via input oscillators 108 and the energy-based model may thermodynamically evolve such that output oscillators 110 represent an output of the energy-based model 104.

FIG. 1B illustrates the EBM and analog SoftMax gadget at a second moment in time, wherein the coupling has been performed, according to some embodiments.

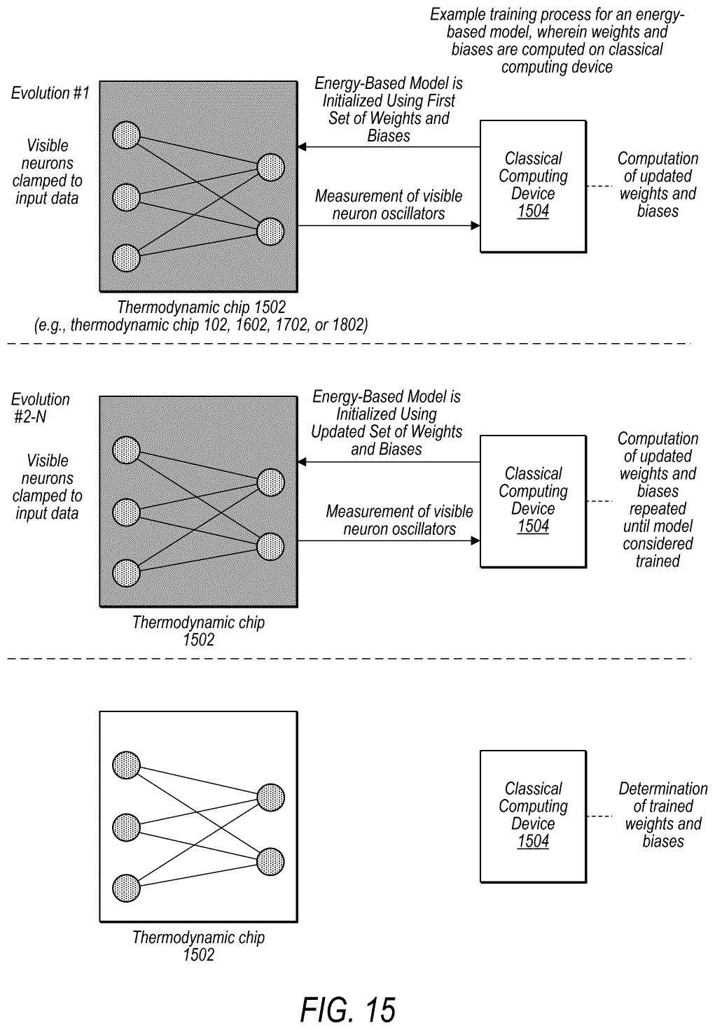

At time T₂ the output oscillators 110 of energy-based model 104 may be coupled to the input/output oscillators 112 of the analog SoftMax gadget 106, for example via couplings 114. Also, in some embodiments, relay oscillators may be used to relay the output values of energy-based model 104 to the input/output oscillators 112 of SoftMax gadget 106. For example, FIG. 1D shows an arrangement with relay oscillators 118. In such embodiments, the relay oscillators 118 may first be coupled to output oscillators 110 of energy-based model 104, such that output values of the energy-based model are relayed to the relay oscillators 118. The relay oscillators 118 may then be coupled to the input/output oscillators 112 of analog SoftMax gadget 106. For example, the couplings 114 may be couplings between relay oscillators 118 and input/output oscillators 112 (instead of couplings between output oscillators 110 and input/output oscillators 112). The couplings 114 provide the input values e.g. ηⱼ, wherein the analog SoftMax gadget 106 takes the argument ηⱼ encoded as position degrees of freedom (ϕ_{η}_{ⱼ}) of the output oscillators 110 (or alternatively relay oscillators 118) and returns the SoftMax result of this input argument, e.g. SoftMax (ηⱼ) in expectation value, wherein position degrees of freedom of the output oscillators of the SoftMax function at any given moment in time is represented by a one-hot encoded vector. Additional details regarding relay oscillator operation is provided below with regard to FIGS. 7-8. Also, additional details regarding how to determine synapse parameters (e.g., weights and biases) of an energy-based model, such as energy-based model 104 are provided below with regard to FIGS. 14-15.

FIG. 1C illustrates the EBM and analog SoftMax gadget at a later moment in time, wherein the analog SoftMax gadget, coupled to the EBM, has thermodynamically evolved under an engineered potential of the analog SoftMax gadget such that the oscillators of the analog SoftMax gadget evolve to have values that encode a one-hot vector, which is the output of the SoftMax function when coupled with the output oscillators of the EBM, according to some embodiments.

At time T₃ the input/output oscillators 112 of the analog SoftMax gadget 106 have reached thermal equilibrium after evolving while being provided input thermodynamic information via couplings 114. The input/output oscillators 112 of the analog SoftMax gadget 106 evolve based on the engineered potential which causes the input/output oscillators 112 to reach a one-hot encoded vector state for the input/output oscillators 112 at any given moment in time. Also, the measured expectation values of the input/output oscillators 112 yield the result of the SoftMax function at thermal equilibrium. For example, the final values (V_{f}) of the input/output oscillators encode the one hot vector 116 in their respective position degrees of freedom and measuring an expectation value of a given one of the input/output oscillators over a period of time at thermal equilibrium returns the SoftMax function result for that position of the input vector provided to the analog SoftMax gadget 106.

FIG. 1D illustrates an example configuration wherein relay oscillators are used to provide an adjustable masses and/or frequencies that allow the output oscillators of the EBM to be treated as static when coupled with the analog SoftMax gadget, according to some embodiments.

As mentioned above, in some embodiments, input providing relay oscillators 118 may be used to relay thermodynamic information to input/output oscillators 112 of analog SoftMax gadget 106. Additional details regarding the use of relay oscillators is provided in FIGS. 7-8. It should be understood that in some embodiments, the second energy-based model shown in FIGS. 7-8 could be an analog SoftMax gadget 106. For example, the input providing relay oscillators 118 may be used to hold respective output values of the output oscillators 110 static. For example, input providing relay oscillators 118 may be coupled to output oscillators 110 with a small product of mass times frequency squared, such that a given input providing relay oscillator 118 takes on a position degree of freedom value of a given output oscillator 110. The mass and/or frequency values of the input providing relay oscillators 118 may then be tuned to a larger value, such that the given input providing relay oscillator 118 holds the relayed position degree of freedom value at a near static value while coupled to a given one of the input/output oscillators 112 of the analog SoftMax gadget 106.

FIG. 1E illustrates an additional example configuration wherein relay oscillators are used to provide adjustable masses and/or frequencies that allow the output oscillators of the EBM to be treated as static when coupled with the analog SoftMax gadget, and wherein additional relay gadgets are used to receive the result of the SoftMax function, implemented thermodynamically via the analog SoftMax gadget coupled to the EBM, wherein the additional relay gadgets store expectation values of the respective input/output oscillators of the analog SoftMax gadget, according to some embodiments.

In some embodiments, other relay oscillators may be used to accept the outputs of the input/output oscillators 112 of the analog SoftMax gadget 106. For example, single relay oscillators or relay gadgets comprising groups of relay oscillators may be coupled via couplings 122 to input/output oscillators 112 of analog SoftMax gadget 106. For example, arrangements using single relay oscillators are shown in FIGS. 7-8. It should be understood that the first energy-based model discussed in FIGS. 7-8 could be an analog SoftMax gadget 106, in some embodiments. In some embodiments, wherein the result receiving relay oscillator 120 is a single relay oscillator, it may be used to sample the input/output oscillators 112. In some embodiments, wherein the result receiving relay gadget 120 is used, the result receiving relay gadget may include a group of relay oscillators configured to store expectation values of the input/output oscillators 112 of analog SoftMax gadget 106. For example, various configurations of relay gadgets are shown in FIGS. 9-12 and may be used as relay gadget 120. It should be understood that in some embodiments, the first energy-based model discussed in FIGS. 9-12 may be an analog SoftMax gadget 106.

FIG. 1F illustrates another example configuration wherein relay gadgets are used to receive the result of the SoftMax function, implemented thermodynamically via the analog SoftMax gadget coupled to the EBM, wherein the relay gadgets capture expectation values of the respective input/output oscillators of the analog SoftMax gadget, according to some embodiments.

Also, it should be noted that in some embodiments, relays or relay gadgets may be used to store output samples or expectation values of the input/output oscillators 112 of analog SoftMax gadget 106, without necessarily needing to use input providing relay oscillators, such as the input providing relay oscillators 118 shown in FIGS. 1D and 1E.

FIG. 2 illustrates an example all-to-all coupling that may be used to couple input/output oscillators (ϕ_{b}) of the analog SoftMax gadget to one another, according to some embodiments.

In some embodiments, the relay oscillators 112 of the analog SoftMax gadget 106 may be coupled to one another in an all-to-all coupling as shown in FIG. 2. However, in configurations with a large number of input/output oscillators, such an all-to-all configuration may be cumbersome to implement. Thus, as further described with regard to FIG. 3, in some embodiments a constructive all-to-all coupling may be used, wherein additional ancilla oscillators are configured in a modified tree-structure to achieve a constructive all-to-all coupling between input/output oscillators 112.

FIG. 3 illustrates another example coupling, wherein additional oscillators (ϕₐ) are used to emulate an all-to-all coupling between input/output oscillators (ϕ_{b}_{ⱼ}) of the analog SoftMax gadget using at most degree-four connectivity, according to some embodiments.

For example, a binary tree type of lattice (e.g. modified tree) may be used to create similar constraints on the input/output oscillators 112 as was the case for the all-to-all coupling shown in FIG. 2. Note that in the engineered potential used to implement the SoftMax function, e.g., V(ϕ_{b}_{₁}, . . . , ϕ_{b}_{_{N}})=A₁Σⱼ₌₁^{N}ϕ_{b}_{ⱼ}²(ϕ_{b}_{ⱼ}−1)²+A₂(Σⱼ₌₁^{N}ϕ_{b}_{ⱼ}−1)², the A₂ constant that is proportional to the second term (e.g., after the plus sign) requires an all-to-all coupling. This is because expanding this term will result in a term proportional to Πⱼ₌₁^{N}ϕ_{b}_{ⱼ}. However, in some embodiments, additional ancillary oscillators 302 as shown in FIG. 3, may be added to reduce the degree of connectivity required between individual ones of the oscillators. For example, for a vector of dimension N each individual oscillator may only require connectivity to four other oscillators as opposed to connectivity to all N−1 other ones of the input/output oscillators 112, as would be the case in a true all-to-all coupling.

For discussion purposes, the additional ancilla oscillators 302 can be considered to belong to a layer (l) and within each layer there are j ancilla oscillators 302. The layer that includes the root node (shown as ϕₐ_{₁} and ϕₐ_{₂}) in FIG. 3 may be referred to as layer 1, e.g. l=1. The next higher layer may be layer 2, e.g., l=2, and so on. A constraint is imposed on the ancilla oscillators 302 in the lowest layer (l=1) such that A₂⁽¹⁾(ϕₐ_{₁}⁽¹⁾−1)² for some large coupling parameter A₂⁽¹⁾. This imposes an energetic penalty if ϕₐ_{₁}⁽¹⁾ deviates from a value of 1. In a layer l the position degree of freedom of two sibling nodes, such as ϕₐ_{ⱼ}^{(l)} and ϕₐ_{ⱼ₊₁}^{(l)}, are further labeled with a subscript s to indicate they are sibling nodes. For example, they may be labeled as ϕₐ_{_{j,s}}^{(l)} and ϕₐ_{_{j+1,s}}^{(l)}. The set of siblings for a given layer above the first layer is [symbol] ^{(l)}. The position degree of freedom of a parent of a given set of sibling nodes is labeled as ϕₐ_{_{j,p}}^{(l-1)}. Using this notation, the potential can be written with an energy constraint, as follows:

$${V}_{A n c i l l a s} = {A}_{2}^{( 1 )} {( {ϕ}_{{a}_{1}}^{( 1 )} - 1 )}^{2} + {\sum }_{l = 2}^{L - 1} {\sum }_{j ∈ {S}^{( l )}} {A}_{2}^{( l )} {( {ϕ}_{{a}_{j , s}}^{( l )} + {ϕ}_{{a}_{( j + 1 ) , s}}^{( l )} - {ϕ}_{{a}_{j , p}}^{( l - 1 )} )}^{2} + {\sum }_{j ∈ {S}^{( L )}} {A}_{2}^{( L )} {( {ϕ}_{a {b}_{j , s}}^{( L )} + {ϕ}_{{b}_{( j + 1 ) , s}}^{( L )} - {ϕ}_{{a}_{j , p}}^{( L - 1 )} )}^{2}$$

The above equation uses the fact that at the bottom of the tree (e.g., the oscillators below layer l=1), the oscillators corresponding to the leaf nodes are the original ϕ_{b}_{ⱼ} oscillators (e.g., the input/output oscillators 112). The above potential adds an energetic penalty in the root node for these leaf nodes (e.g., ϕₐ_{₁} and ϕₐ_{₂} as shown in FIG. 3) if the root node is not one. Additionally, an energetic penalty is added if the children of all of the root nodes do not sum to ϕₐ_{₁}⁽¹⁾, which should be 1. These conditions are added recursively until the leaf nodes are reached. The overall potential is then updated as:

$$V ( {ϕ}_{{b}_{1}} , … , {ϕ}_{{b}_{N}} ) = {A}_{1} {\sum }_{j = 1}^{N} {ϕ}_{{b}_{j}}^{2} {( {ϕ}_{{b}_{j}} - 1 )}^{2} + {V}_{A n c i l l a s} .$$

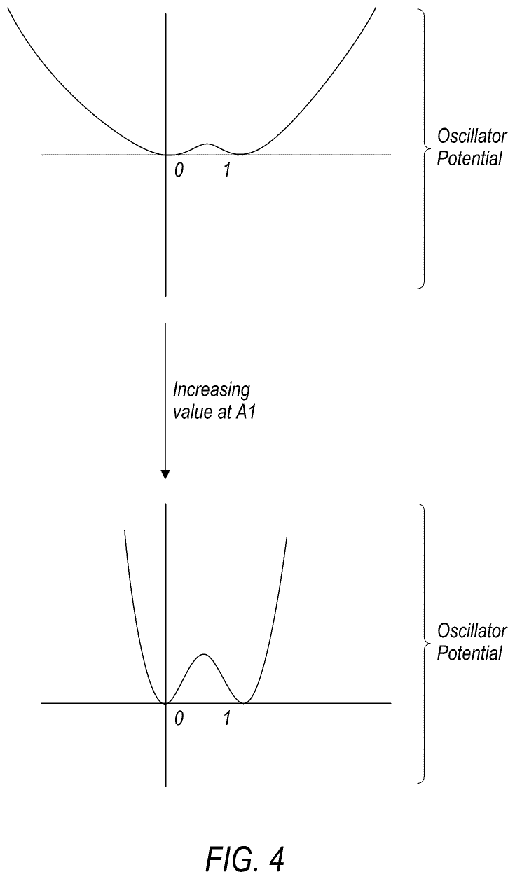

FIG. 4 illustrates graphs of potentials for a given oscillator of the analog SoftMax gadget, wherein the given oscillator has a dual-well potential. FIG. 4 further illustrates how increasing the parameter A₁ in an engineered potential for the analog SoftMax gadget causes the walls and intermediate barrier between the two wells of the dual-well potential to be more steep, such that the dual-well oscillator is more likely to evolve to a value of 0 or 1 as required by the engineered potential for the analog SoftMax gadget, according to some embodiments.

The respective input/output oscillators 112 of the analog SoftMax gadget 106 may be implemented using dual-well potential oscillators. Furthermore, selecting an appropriate value for A₁ that is large creates an energetic penalty for values other than zero or one. This is illustrated in FIG. 4, wherein increasing the value of A₁ increases the well walls and the barrier between the wells, such that the minima of each of the wells is at zero or one.

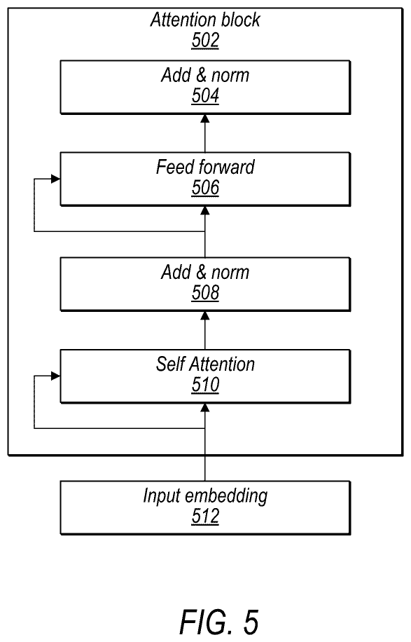

FIG. 5 illustrates an example attention block of a machine learning model, that may be implemented in an analog manner using one or more thermodynamic chips, wherein an analog SoftMax gadget is used at least in part to implement the self-attention layer, according to some embodiments.

In some embodiments, an analog SoftMax gadget may be used as part of a thermodynamic implementation of a machine learning model. For example, in some embodiments a plurality of energy-based models may be used to implement functions of an attention block 502. For example, EBMs may be used to thermodynamically implement an Addition and Normalization layer 504, a Feed Forward layer 506, another Addition and Normalization layer 508, a Self-Attention layer 510, and Input Embedding 512. More specifically, an analog SoftMax gadget 106 may be one of a set of EBMs used to implement the Self-Attention layer 510.

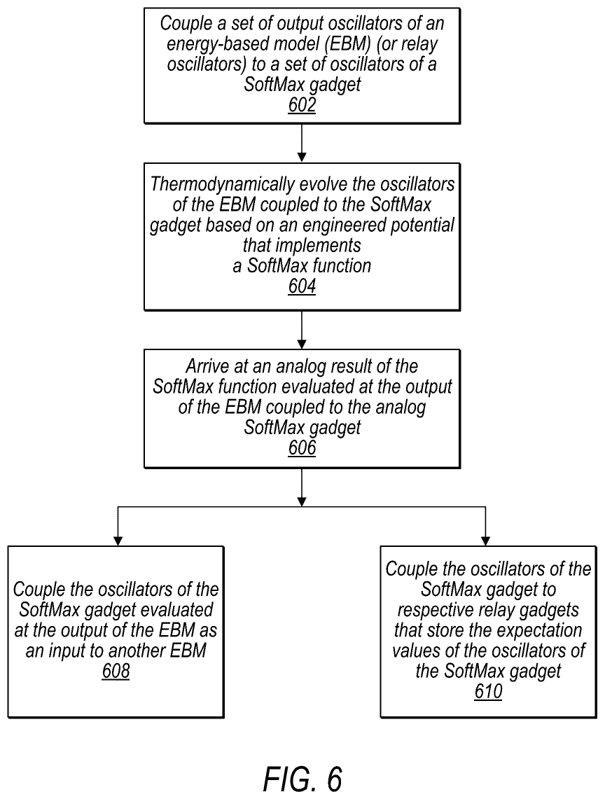

FIG. 6 is a flowchart illustrating a process for implementing a SoftMax function using an analog SoftMax gadget, according to some embodiments.

At block 602, a set of output oscillators of an energy-based model (or relay oscillators) are coupled to a set of input/output oscillators of an analog SoftMax gadget. Then, at block 604, the oscillators (including the input-output oscillators and ancilla oscillators (if used)) are allowed to thermally evolve, e.g. to reach a thermal equilibrium. This evolution is performed based on an engineered potential for the analog SoftMax gadget which creates energetic penalties that drive the oscillators to thermodynamically evolve to a one-hot encoded vector state (e.g., one input/output oscillator having a position degree of freedom value of one, and all other input/output oscillators having a position degree of freedom value of zero). For example, at block 606 (after the thermal evolution) the input/output oscillators of the analog SoftMax gadget arrive at an analog result of the SoftMax function that comprises a one hot encoded vector at the input/output oscillators of the analog SoftMax gadget.

At block 608, the input/output oscillators of the analog SoftMax gadget are coupled to another EBM or other device that is to receive the result of the SoftMax function. This could be another EBM, relay oscillators, measurement, etc.

As another alternative, at block 610 the input/output oscillators of the analog SoftMax gadget are coupled to relay gadgets, such as shown in FIGS. 1E and 1F, wherein the relay gadgets have any of the configurations shown in FIGS. 9-12. The relay gadgets store respective expectation values of the input/output oscillators of the analog SoftMax gadget.

FIG. 7A is high-level diagram illustrating a first energy-based model (EBM) implemented using a thermodynamic chip, a second energy-based model (EBM) implemented using a thermodynamic chip, and a relay gadget implemented using a thermodynamic chip, wherein the relay gadget is configured to relay thermodynamic information between the first energy-based model (EBM) and the second energy-based model (EBM), according to some embodiments.

In some embodiments, a relay oscillator gadget, such as relay oscillator gadget 118, receives thermodynamic information from an input source, such as oscillator 706, and relays the thermodynamic information to an output destination, such as oscillator 708. In some embodiments, the oscillator 706 may be an output oscillator 706 of a first energy-based model (EBM) 700 and the oscillator 708 may be an input oscillator 708 of a second energy-based model (EBM) 702. In some embodiments, the thermodynamic information being relayed from the output oscillator 706 to the input oscillator 108 may be a position degree of freedom. As such, FIG. 7A shows an output position degree of freedom (ϕ_{y}) of the output oscillator 706 and an input position degree of freedom (ϕₓ) of the input oscillator 708, as well as a relay position degree of freedom (ϕᵣ) of the relay oscillator 718 and a bias position degree of freedom (ϕ_{b}) of the bias oscillator 712. Additionally, controller 714 is shown, which may be an on-chip controller. Controller 714 causes pulses to be emitted in a time dependent manner to orchestrate coupling of the relay oscillator 118 to the output oscillator 706, coupling of the relay oscillator 118 to the bias oscillator 712, adjustment of a mass or frequency of the relay oscillator 118, and a coupling of the relay oscillator 118 to the input oscillator 708. In some embodiments, the controller 714 may be pre-programmed to emit the relevant pulses and control signals in a time dependent sequence in order to execute a relay operation.

An example Hamiltonian of the coupled system shown in FIG. 7A is given by:

$${H}_{fan} = \frac{{π}_{r}^{2}}{2 {m}_{r} ( t )} + \frac{{π}_{y}^{2}}{2 {m}_{y}} + \frac{{π}_{x}^{2}}{2 {m}_{x}} + \frac{{π}_{b}^{2}}{2 {m}_{b}} + \frac{1}{2} {m}_{r} ( t ) {ω}_{r}^{2} ( t ) {ϕ}_{r}^{2} + \frac{1}{2} {m}_{b} {ω}_{b}^{2} {ϕ}_{b}^{2} \text{} + \frac{1}{2} {m}_{y} {ω}_{y}^{2} {( {ϕ}_{y} - {y}_{e} )}^{2} + \frac{1}{2} {m}_{x} {ω}_{x}^{2} {ϕ}_{x}^{2} + {λ}_{A} ( t ) {( {ϕ}_{y} - {ϕ}_{r} )}^{2} + {λ}_{B} ( t ) {ϕ}_{b} {ϕ}_{r} + {λ}_{X} ( t ) {ϕ}_{r} {ϕ}_{X}$$

Note that the terms in the Hamiltonian including the λ_{A}, λ_{B}, and λ_{X} terms describe the coupling between the relay oscillators and the other three oscillators, e.g., the output oscillator 706, the bias oscillator 712, and the input oscillator 708. Also, note that all three coupling terms are time dependent, based on the λ_{A}, λ_{B}, and λ_{X} pulses controlled by controller 714. Additionally, note that the mass (or the frequency) of the relay oscillator 118 is time dependent, where the mass (or frequency) of the relay oscillator is also controlled by controller 714.

More particularly, the controller 714 emits pulses λ_{A} to couple the position degree of freedom (ϕ_{y}) of the output oscillator 706 to the position degree of freedom (ϕᵣ) of the relay oscillator 118. This coupling may remain turned on for some time. Then, once the coupling between the position degree of freedom (ϕ_{y}) of the output oscillator 706 and the position degree of freedom (ϕᵣ) of the relay oscillator 118 is turned off, the controller 714 causes pulses λ_{B} to be emitted to couple the position degree of freedom (ϕᵣ) of the relay oscillator 118 to the position degree of freedom (ϕ_{b}) of the bias oscillator 712, and simultaneously emits control signals to cause the mass of the relay oscillator 118 to be increased (or alternatively emits control signals to cause the oscillation frequency of the relay oscillator 118 to be tuned, for example decreased). When coupled to the relay oscillator 118, the bias position degree of freedom (ϕ_{b}) of the bias oscillator 712 acts as a bias to the relay oscillator 118 and helps to ensure that the relay position degree of freedom (ϕᵣ) of the relay oscillator 118 maintains its equilibrium value (that it has acquired from the output oscillator 706). After the relay oscillator 118 has reached an appropriately large mass (or tuned frequency), the controller 714 causes pulses λ_{X} to be emitted to couple the position degree of freedom (ϕᵣ) of the relay oscillator 118 (having the increased mass or tuned frequency) to the position degree of freedom (ϕ_{X}) of the input oscillator 708. Also, in some embodiments, the controller 714 may cause pulses λ_{X} and pulses λ_{B} to be emitted at the same time, such that the relay oscillator 118 is coupled to the bias oscillator 712 simultaneously with being coupled to the input oscillator 708. Note that in the illustration shown in FIG. 7A either of EBMs 700 or 702 may be an analog SoftMax gadget 106, that is to say the input to the relay oscillator may come from the analog SoftMax gadget 106 or the destination of the information being relayed may be the SoftMax gadget 106. FIG. 7A is illustrating a more general case for the relay gadget where the inputs and outputs are general EBMs, but it should be understood that the analog SoftMax gadget is a particular implementation of an EBM having an engineered potential that implements the SoftMax function.

In some embodiments the following pulse shapes may be used for JA, AB, and Ax. Though in some embodiments, other suitable pulse shapes may be used.

$${λ}_{A} ( t ) = {λ}_{A} ( σ ( {k}_{A} ( t - {t}_{1} ) ) - σ ( {k}_{A} ( t - {t}_{2} ) ) )$$

$${λ}_{B} ( t ) = - {λ}_{B} σ ( {k}_{B} ( t - {t}_{1}^{( B )} ) ) + {λ}_{0}^{( B )}$$

$${λ}_{X} ( t ) = {λ}_{X} σ ( {k}_{X} ( t - {t}_{1}^{( X )} ) ) + {λ}_{0}^{( X )}$$

where σ(t) is the sigmoid function:

$$σ ( t ) = \frac{1}{1 + {e}^{- t}} .$$

In some embodiments, λ_{A}, λ_{B}, and λ_{X}, as well as k_{A}, k_{B}, and k_{X} may be tuned to improve results. Also, t₁, t₂, t₁^{(B)}, and t₁^{(X)} may be tuned.

Without loss of generality, the position degree of freedom of the output oscillator 706 (ϕ_{y}) is considered to have an equilibrium value (yₑ) (after energy-based model 700 has evolved for some time and reached a thermal equilibrium). Also, the position degree of freedom (ϕ_{y}) of the output oscillator 706 is considered to have a potential given by ½m_{y}ω_{y}²(ϕ_{y}−yₑ)². It should be noted in practice that the output oscillator 706 may be coupled to various other oscillators of the first energy-based model 700 (as shown in FIG. 7A) which would cause it to have the yₑ equilibrium value. Thus, to be more comprehensive, ½m_{y}ω_{y}²(ϕ_{y}−yₑ) may be replaced by a potential term that takes into account these couplings, such as ½m_{y}ω_{y}²(ϕ_{y}−yₑ)²+Σⱼλ_{Y}^{(j)}φ_{y}φⱼ or ½m_{y}ω_{y}²(φ_{y}−yₑ)²+λ_{Y}Σⱼλ_{Y}^{(j)}(φ_{y}−φⱼ)², where the ϕⱼ degrees of freedom are degrees of freedom of other oscillators in the first energy-based model 700 that are coupled to the position degree of freedom (ϕ_{y}) of the output oscillator 706. However, this difference (or said another way, simplification) manifests itself in a slightly different value for the equilibrium value (yₑ), or depending on the couplings, may result in the same yₑ equilibrium value. But this simplification does not affect the equilibrium results of the relay oscillator 118. A similar issue applies to the input oscillator 708, which is also coupled to other oscillators of the second energy-based model 702. Also, in some embodiments, multiple relay oscillators 710 may be coupled to multiple input oscillators (e.g. additional input oscillators in addition to input oscillator 708). Note that the relay oscillator 118 and the relay gadget 704 impart the equilibrium value of the output oscillator to the input oscillator, such that the position degree of freedom (ϕ_{X}) of the input oscillator 708 inherits the same equilibrium value as the position degree of freedom (ϕ_{y}) of the output oscillator 706, e.g. the position it had when first coupled to the relay oscillator 118 of the relay gadget 704. As such, thermodynamic information is relayed from the output oscillator 706 to the input oscillator 708 while remaining in a thermodynamic state. For example, analog information is passed between the first energy-based model 700 and the second energy-based model 702 without requiring a measurement by a classical computing device. Further note, this is done in an analog way (as opposed to a digitization that would take place during readout and re-initialization).

For a system undergoing Langevin dynamics, the equation of motion of a given oscillator (k) is given by:

$$\frac{d {φ}_{k} ( t )}{d t} = \frac{\partial {H}_{fan}}{\partial {π}_{k}}$$

$${\frac{{π}_{k} ( t )}{d t} = - γ {π}_{k} ( t ) - \frac{\partial {H}_{fan}}{\partial {φ}_{k}} \vert}_{t} + \sqrt{2 {m}_{k} γ {k}_{B} T} \frac{d {W}_{t}}{d t}$$

where φ denotes the position degree of freedom of the oscillator and π denotes the momentum degree of freedom of the oscillator. Using the Hamiltonian for the coupled system shown in FIG. 7A (which is given further above) and the equations of motion for position and momentum given directly above, the equations of motions for the relay oscillator 118, output oscillator 106, the bias oscillator 712, and the input oscillator 708, are respectively given by:
Equation of motion for the relay oscillator:

$${m}_{r} ( t ) \frac{{d}^{2} {ϕ}_{r}}{d {t}^{2}} + \frac{d {m}_{r} ( t )}{dt} \frac{d {ϕ}_{r}}{dt} + γ {m}_{r} ( t ) \frac{d {ϕ}_{r}}{d t} = \text{} - ( - 2 {λ}_{A} ( t ) ( {ϕ}_{y} - {ϕ}_{r} ) + {λ}_{B} ( t ) {ϕ}_{b} + {λ}_{X} ( t ) {ϕ}_{x} + {m}_{r} ( t ) {ω}_{r}^{2} {ϕ}_{r} ) + \sqrt{2 {m}_{r} ( t ) {k}_{B} T} \frac{d {W}_{t}^{( r )}}{d t}$$

$$Or$$

$${m}_{r} ( t ) \frac{{d}^{2} {φ}_{r}}{d {t}^{2}} + \frac{d {m}_{r} ( t )}{dt} \frac{d {φ}_{r}}{dt} + γ {m}_{r} ( t ) \frac{d {φ}_{r}}{d t} = \text{} - ( - 2 {λ}_{A} ( t ) ( {φ}_{y} - {φ}_{r} ) - 2 {λ}_{B} ( t ) ( {φ}_{b} - {φ}_{r} ) + 2 {λ}_{X} ( t ) ( {φ}_{r} - {φ}_{x} ) + {m}_{r} ( t ) {ω}_{r}^{2} {φ}_{r} ) + \sqrt{2 {m}_{r} ( t ) {k}_{B} T} \frac{d {W}_{t}^{( r )}}{d t}$$

Depending on whether there is a linear or quadratic coupling.
Equation of motion for the output oscillator:

$${m}_{y} \frac{{d}^{2} {φ}_{y}}{d {t}^{2}} + γ {m}_{y} \frac{d {φ}_{y}}{d t} = - ( {λ}_{A} ( t ) {φ}_{y} + {m}_{y} {ω}_{y}^{2} ( {φ}_{y} - {φ}_{c} ) ) + \sqrt{2 {m}_{y} {k}_{B} T} \frac{d {W}_{t}^{( y )}}{d t}$$

$$Or$$

$${m}_{y} \frac{{d}^{2} {φ}_{y}}{d {t}^{2}} + γ {m}_{y} \frac{d {φ}_{y}}{d t} = \text{} - ( 2 {λ}_{A} ( t ) ( {φ}_{y} - {φ}_{r} ) + {m}_{y} {ω}_{y}^{2} ( {φ}_{y} - {φ}_{c} ) ) + \sqrt{2 {m}_{y} {k}_{B} T} \frac{d {W}_{t}^{( y )}}{d t}$$

Depending on whether there is a linear or quadratic coupling.
Equation of motion for the bias oscillator:

$${m}_{b} \frac{{d}^{2} {φ}_{b}}{d {t}^{2}} + γ {m}_{b} \frac{d {φ}_{b}}{d t} = - ( {λ}_{B} ( t ) {φ}_{γ} + {m}_{b} {ω}_{b}^{2} {φ}_{b} ) + \sqrt{2 {m}_{b} {k}_{B} T} \frac{d {W}_{t}^{( b )}}{d t}$$

$$Or$$

$${m}_{b} \frac{{d}^{2} {φ}_{b}}{d {t}^{2}} + γ {m}_{b} \frac{d {φ}_{b}}{d t} = - ( - 2 {λ}_{B} ( t ) ( {φ}_{γ} - {φ}_{b} ) + {m}_{b} {ω}_{b}^{2} {φ}_{b} ) + \sqrt{2 {m}_{b} {k}_{B} T} \frac{d {W}_{t}^{( b )}}{d t}$$

Depending on whether there is a linear or quadratic coupling.
Equation of motion for the input oscillator:

$${m}_{x} \frac{{d}^{2} {φ}_{x}}{{dt}^{2}} + γ {m}_{x} \frac{d {φ}_{x}}{d t} = - ( {λ}_{X} ( t ) {φ}_{r} + {m}_{x} {ω}_{x}^{2} {φ}_{x} ) + \sqrt{2 {m}_{x} {k}_{B} T} \frac{d {W}_{t}^{( x )}}{d t}$$

$$Or$$

$${m}_{x} \frac{{d}^{2} {φ}_{x}}{d {t}^{2}} + γ {m}_{x} \frac{d {φ}_{x}}{d t} = - ( - 2 {λ}_{X} ( t ) ( {φ}_{r} - {φ}_{x} ) + {m}_{x} {ω}_{x}^{2} {φ}_{x} ) + \sqrt{2 {m}_{x} {k}_{B} T} \frac{d {W}_{c}^{( x )}}{d t}$$

Depending on whether there is a linear or quadratic coupling.

Also, the time dependent mass of the relay oscillator 110 is given by:

$${m}_{r} ( t ) = {m}_{f}^{( r )} σ ( {k}_{r} ( t - {t}_{r} ) ) + {m}_{r} .$$

FIG. 7B is a high-level diagram similar to FIG. 7A, wherein the relay gadget does not include a bias oscillator, according to some embodiments.

In some embodiments, such as when the relay oscillator is configured to have a controllable time-dependent mass, the use of a bias oscillator may be omitted. For example, if the product of mass times frequency squared of a first oscillator is much larger than the product of mass times frequency of a second oscillator (that is coupled to the first oscillator) the position degree of freedom of the first oscillator (having the larger value for the product of mass times frequency squared) may be treated as a constant. Thus, for embodiments, wherein the mass of the relay oscillator can be increased such that the product of mass times frequency squared of the relay oscillator is sufficiently large, it may not be necessary to further use a bias oscillator.

More particularly, consider two oscillators (oscillator a and oscillator b) with position degrees of freedom ϕₐ and ϕ_{b}. Suppose that op has equilibrium value b_{c}. Assume ϕ_{b} is a constant and consider the Hamiltonian:

$${H}_{1} = \frac{1}{2} {m}_{a} {ω}_{a}^{2} {ϕ}_{a}^{2} + λ {ϕ}_{a} {b}_{c}$$

In this case, the expectation value of Pa at thermal equilibrium is given by:

$$〈 {ϕ}_{a} 〉 = \frac{\int {ae}^{- β {H}_{1}} d a}{\int {e}^{- β {H}_{1}} d a} = \frac{λ {b}_{c}}{{m}_{a} {ω}_{a}^{2}}$$

Choosing λ=−mₐωₐ², it gives [symbol] ϕₐ [symbol] =b_{c}.

Also, considering the dynamics of ϕ_{b}. The Hamiltonian is:

$${H}_{2} = \frac{1}{2} {m}_{a} {ω}_{a}^{2} {ϕ}_{a}^{2} + \frac{1}{2} {m}_{b} {ω}_{b}^{2} {( {ϕ}_{b} - {b}_{c} )}^{2} + λ {ϕ}_{a} {ϕ}_{b}$$

Moreover, using H₂, [symbol] ϕₐ [symbol] is given by:

$$〈 {φ}_{a} 〉 = \frac{\int {ae}^{- β {H}_{2}} da db}{\int {e}^{- β {H}_{2}} da db} = - \frac{λ {b}_{c}}{{m}_{b} {ω}_{a}^{2} - \frac{{λ}^{2}}{{m}_{b} {ω}_{b}^{2}}} = \frac{{b}_{c}}{1 - \frac{{m}_{a} {ω}_{a}^{2}}{{m}_{b} {ω}_{b}^{2}}}$$

where λ is set such that λ=−mₐωₐ². Note that if mₐωₐ². <<m_{b}ω_{b}², then [symbol] ϕₐ [symbol] ≈b_{c}. As such as long as the mass times frequency squared of the oscillator a having position degree of freedom ϕₐ is much less than the mass times frequency squared of the oscillator b having position degree of freedom ϕ_{b}, the position degree of freedom ϕ_{b} can be treated as a constant, with the constant being the thermal equilibrium value of ϕ_{b}.

Said another way, if the product of mass times frequency squared of the relay oscillator 118 is increased to be sufficiently large, then the inherited equilibrium value acquired from the output oscillator 706 can be treated as a constant, while held by the relay oscillator 118. Also, as long as the product of mass times frequency squared of the relay oscillator 118 is sufficiently large as compared to the corresponding value of mass times frequency squared of the input oscillator 708, the position degree of freedom of the relay oscillator may be treated as a constant, such that it relays the held equilibrium value acquired from the output oscillator 706 of the first EBM 700 to the input oscillator 708 of the second EBM 702.

Note that the relay oscillators used in the relay gadget configurations shown in FIGS. 9-12, include bias oscillators. However, in some embodiments, similar configurations may be used that do not include bias oscillators. For example, relay oscillators as shown in FIG. 7A or as shown in FIG. 7B may be used to construct the relay gadgets shown in FIGS. 9-12.

FIG. 8 is a high-level flowchart illustrating a process of relaying thermodynamic information between an output oscillator, such as of a first energy-based model (EBM), and an input oscillator, such as of a second energy-based model (EBM), according to some embodiments.

At block 800 a relay oscillator is initialized, wherein the relay oscillator is positioned such that it has connectivity to an output oscillator, such as output oscillator 706 of energy-based model 700, and has connectivity to an input oscillator, such as input oscillator 708 of energy-based model 702. Additionally, a bias oscillator is initialized, wherein the bias oscillator has connectivity to the relay oscillator. For example, bias oscillator 712 may be initialized and is positioned in a way that it can be coupled to relay oscillator 118.

At block 802, the first energy-based model comprising the output oscillator, such as energy-based model 700 that includes output oscillator 706, is enabled to undergo thermal evolution such that the energy-based model evolves according to Langevin dynamics. The evolution may be enabled to occur for an amount of time such that the first energy-based model reaches a thermal equilibrium. As an example, the first energy-based model may represent a trained model that is configured to perform inference, and at least some oscillators of the first energy-based model may be clamped to input data, wherein inference results are represented by other oscillators of the first energy-based model subsequent to the thermal evolution. For example, output oscillator 706 may represent the results of a computation performed by the energy-based model 700 that are to be relayed as input data to the second energy-based model 702.

At block 804, once the oscillators of the first energy-based model (e.g. energy-based model 700) have reached thermal equilibrium, the controller 714 initiates pulses (e.g. λ_{A}(t) pulses) to cause the output oscillator 706 to be coupled to the relay oscillator (e.g. relay oscillator 118).

At block 806, the controller 714 initiates additional pulses (e.g., λ_{B} (t) pulses) that cause the relay oscillator to be coupled to the bias oscillator. Recall that initially the relay oscillator 118 may have a small mass and/or frequency combination, e.g., small relative to the product of mass times frequency squared of the output oscillator 706. Because the relay oscillator has a small product of mass times frequency squared, the relay oscillator more readily takes on the position of the output oscillator (for example, as opposed to the relay oscillator pulling the output oscillator to take on the relay oscillator's position). However, due to the relatively small mass times frequency squared of the relay oscillator, if left alone the relay oscillator would quickly lose the recently inherited position, inherited from the output oscillator. To avoid this, the relay oscillator is coupled to the bias oscillator 712 at or near the same time as the relay oscillator is un-coupled from the output oscillator 706. The relay oscillator may also be coupled to the bias oscillator at or near the same time it is coupled to the input oscillator 708. Coupling the relay oscillator to the bias oscillator helps the relay oscillator to maintain the acquired thermal information (e.g., position degree of freedom, or, in some embodiments, momentum degree of freedom) the relay oscillator has acquired from the output oscillator. Also, while coupled to the bias oscillator and prior to being coupled to the input oscillator of the next EBM, a mass and/or frequency of the relay oscillator is adjusted.

For example, at block 808, the controller 714 causes control signals to be emitted that cause the mass (or frequency) of the relay oscillator to be adjusted. The mass of the relay oscillator may be proportional to capacitance of a circuit used to implement the relay oscillator; a Cooper-pair box arrangement may be used to implement a time dependent capacitance in the circuit (e.g. where the capacitance corresponds to mass). In such embodiments, the controller 714 is configured to emit control signals to cause the Cooper-pair box to increase the capacitance of the relay oscillator circuit. However, in other embodiments, mass may be kept constant, but instead frequency of the relay oscillator may be adjustable as a result of a time-dependent flux element of a circuit used to implement the relay oscillator. For example, a current inducing flux element may be added to the relay oscillator circuit. In such embodiments, controller 714 may emit control signals that cause the flux of the relay oscillator to be tuned (where flux corresponds to frequency). In some embodiments blocks 806 and 808 are performed concurrently.

At block 810, the controller 714 initiates another set of one or more pulses (e.g., λ_{X}(t) pulses) to couple the relay oscillator to the input oscillator, such as input oscillator 708. The bias oscillator 712 may remain coupled to the relay oscillator 118 when the relay oscillator 118 is coupled to the input oscillator 708. Note that since the relay oscillator has had its mass (and/or frequency) adjusted prior to the coupling to the input oscillator, and since the relay oscillator remains coupled to the bias oscillator, the relay oscillator has a large value of the product of mass times frequency squared relative to the input oscillator and therefore causes the input oscillator to take on the position of the relay oscillator, which corresponds to the position of the output oscillator. In this way, the relay gadget 704 relays analog oscillator degree of freedom information (e.g. thermodynamic information) from the output oscillator to the input oscillator, without having to convert the thermodynamic information into classical form.

In some embodiments, a relay gadget, such as relay gadget 704, may perform steps similar to those described in FIG. 8 in order to relay position degree of freedom thermodynamic information, momentum degree of freedom thermodynamic information, and/or force/acceleration degree of freedom thermodynamic information.

In some embodiments, a relay gadget, such as relay gadget 704 may be used to store thermodynamic information, for example in the relay oscillator 118. Also, in some embodiments, multiple relay gadgets may be used to form a thermodynamic network between thermodynamic components. Also, in some embodiments, a relay gadget may be used to perform conditional sampling, such as Gibbs sampling.

FIG. 9 is a high-level diagram illustrating an output oscillator, an input oscillator, and a relay gadget, wherein the relay gadget comprises a group of relay oscillators and is configured to relay expectation values of thermodynamic information between the output oscillator and the input oscillator, according to some embodiments.

In some embodiments, it is desired to transfer an expectation value of one energy-based model (EBM) to another EBM, such as from an output of analog SoftMax gadget 106 to an input of another EBM. In some embodiments an instantaneous sample value may be transferred from an output oscillator of one EBM (such as from a given input/output oscillator 112 of analog SoftMax gadget 106) to an input oscillator of another EBM. The instantaneous sample value of an output oscillator of a given EBM will follow a probability distribution associated with the potential well of the output oscillator and couplings of the output oscillator with the one or more oscillators belonging to the first EBM. An instantaneous sample value of the state of the output oscillator may be any possible value within the bounds of the potential well and respective couplings. In some instances, the instantaneous sample value of the output oscillator may be far off from the expectation value (e.g. due to thermodynamic fluctuations, anharmonic potentials, multiple well potentials, the coupling between the output oscillator with other oscillators belonging to a shared EBM, or a combination of factors). Furthermore, the output oscillator of an EBM may hop between wells of a potential, thus the expectation value may not be a probable outcome of an instantaneous sample of the output oscillator. To avoid these issues, in some embodiments expectation values may be stored instead of sample values and relayed as inputs to other EBMs.

In some embodiments, to enable an expectation value of an output of an EBM to be used as an input to a subsequent EBM in a fully analogue fashion (e.g. without the use of measurements), two or more relay oscillators may be used. In some embodiments, an expectation value is derivable from one or more sample values. In some embodiments, relay oscillators may be oscillators which may be arranged between the output of a given EBM and the input of an additional EBM in such a way that their state may be configured to take on a sample value of the output oscillators of a given EBM. In some embodiments, sample values may be collected in such a way (e.g. spatial or temporal arrangement of relay oscillators as described below) that a close approximation of an expectation value of an output of a given EBM may be represented on one or more relay oscillators. Classical controllers may be used to turn the couplings on and off between the output oscillators and relay oscillators, between respective relay oscillators, as well as to make the masses and frequencies of the relay oscillators time dependent. Nevertheless, measurements may not be required, and the timing of the operations may be computed during a compilation step.

In some embodiments, a relay gadget may include a group of one or more relay oscillators and an additional relay oscillator. One or more relay oscillators of the group of relay oscillators may be coupled to an output oscillator of a first EBM. The one or more relay oscillators may be coupled in such a way that respective sample values of the output oscillator of the first EBM, wherein the output oscillator has progressed through thermodynamic evolution, may be stored on respective ones of the relay oscillators of the first group of one or more relay oscillators. An additional relay oscillator may be coupled to one or more of the relay oscillators, wherein the coupling enables the additional relay oscillator to take on an expectation value of the output oscillator, wherein the expectation value is derivable based at least in part on the sample values. In some embodiments, bias oscillators may be used. In some embodiments, bias oscillators may not be used. For simplicity, embodiments are given with bias oscillators, but it should be understood that is some embodiments bias oscillators may not be used for each relay oscillator of a relay gadget, however, that does not limit the embodiments to only one way or the other.

In some embodiments, thermodynamic information is relayed from a first energy-based model (EBM) 900 to a second energy-based model (EBM) 902 via relay gadget 120. The thermodynamic information of EBM 900 is outputted via output oscillator 906 and inputted into input oscillator 908 via relay gadget 120. The thermodynamic information may include, for example, samples of thermodynamic equilibrium of output oscillator 906, or the expectation value of the output oscillator 906. The expectation value is at least derivable based on samples values of the output oscillator 906. Output oscillator 906 may be governed by a potential wherein the potential follows a single-well potential, double-well potential, multi-well potential, or any generic potential that may be engineered. The output oscillator 906 may also be coupled to other oscillators belonging to EBM 900. More specifically, output oscillator 906 may be an input/output oscillator 112 of analog SoftMax gadget 106.

In some embodiments, an expectation value of one or more degrees of freedom of output oscillator 906 may be influenced by a potential of output oscillator 906 as well as couplings between output oscillator 906 and one or more oscillators belonging to first energy-based model 900. Potentials governing the dynamics of the output oscillator 906 may have multiple wells. With generic arbitrary potentials (e.g. multiple wells) and coupling between output oscillator 906 and one or more oscillators belonging to first energy-based model 900, the position degrees of freedom of the output oscillators can hop between wells. As described herein, a relay gadget provides a solution to approximate an expectation value of the output oscillator. For example, using an approximated expectation value in forwards and backwards propagation may provide better results than using a sample value, as the expectation value better represents the state of the oscillator whose degree of freedom value is being relayed to a second oscillator.

Relay gadget 120 comprises a group of relay oscillators 910 and an additional relay oscillator 912. The group of relay oscillators 910 comprises one or more relay oscillators arranged with respective bias oscillators (e.g., relay oscillator 916 arranged with bias oscillator 918). As described later, relay oscillators in oscillator group 910 may be configured and coupled in various ways (e.g. temporally and spatially) to transfer thermodynamic information. The additional relay oscillator 912 is connected to bias oscillator 920. As discussed later, the additional relay oscillator 912 may be configured and coupled in various ways to transfer thermodynamic information. For example, the group of relay oscillators 910 transfers thermodynamic information to additional relay oscillator 912 via coupling 924. Coupling 924 may be controlled by on-chip classical controller 914.

Output oscillator 906 is coupled to the one or more relay oscillators of the group of relay oscillators 910 via on-chip classical controller 914. On-chip classical controller 914 may send a pulse or a group of pulses to cause couplings between oscillators (e.g., coupling between output oscillator 906 and relay oscillator 916) or relay oscillators like 916 and a bias oscillator like 918 via pulses 930. Coupling is represented by coupling 922, 924, 926 and oscillators may be coupled or not coupled. When coupling is on, parameters of respective coupled oscillators affect the other oscillator it is coupled to. Couplings between oscillators within the group of relay oscillators 910 are not expressly shown in FIG. 9 to emphasize that the coupling may take different configurations (e.g. temporal or spatial configurations as detailed below). Nevertheless, on-chip classical controller 914 may cause a first set of one or more pulses to be emitted through controller connection 928, wherein the first set of pulses couples one or more relay oscillators of the group of relay oscillators 910 to the output oscillator 906 (e.g., turn on coupling 922). The on-chip classical controller 914 is further configured to cause a second set of one or more pulses to be emitted through path 932, wherein the second set of pulses couples one or more relay oscillators of the group of relay oscillators 910 to the additional relay oscillator 912 (e.g., turn on coupling 924). The on-chip classical controller 914 is further configured to cause a third set of one or more pulses (for example, set of pulses 938) to be emitted, wherein the third set of pulses 938 couples the additional relay oscillator 912 to the input oscillator 108 (e.g., turn on coupling 926).

In some embodiments, an additional relay oscillator 912 takes on an expectation value of an output oscillator 906 based at least in part on a coupling or couplings between a group of relay oscillators 910, wherein respective relay oscillators of group 910 comprise respective sample values of the output oscillator 906. The additional relay oscillator 912 may take on the expectation value of output oscillator 906 based at least on respective sample values taken on by respective relay oscillators. Furthermore, additional relay oscillator 912 may transfer the taken on expectation value to input oscillator 908 via controller 914 causing coupling 926 to turn on.

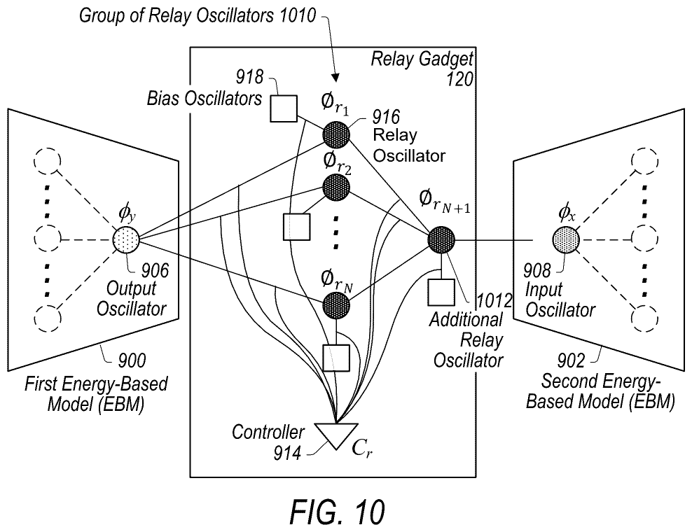

FIG. 10 is a high-level diagram illustrating a spatial analogue relay gadget, wherein respective ones of relay oscillators of a group of relay oscillators are configured to store respective sample values of an output oscillator, according to some embodiments.

In some embodiments, controller 914 sends a first set of one or more pulses wherein the first set of pulses causes output oscillator 906 of first energy-based model (EBM) 900 to be coupled to at least one or more relay oscillators {ϕᵣ_{₁}, ϕᵣ_{₂}, . . . ϕᵣ_{_{N}}}, in the group of relay oscillators 1010. The group of relay oscillators 1010 comprises a plurality of relay oscillators, wherein respective relay oscillators {ϕᵣ_{₁}, ϕᵣ_{₂}, . . . ϕᵣ_{_{N}}}, are configured to store a sample of the output oscillator 906 based at least in part on respective couplings between the respective ones of the relay oscillators (e.g., 916) of the group of relay oscillators 1010 and the output oscillator 906. The on-chip classical controller 914 is further configured to cause another set of one or more pulses to be emitted, wherein the other set of pulses turns off the respective couplings between the output oscillator 906 and the respective ones of the relay oscillator of the group of relay oscillators 1010 at different times. This may allow different samples of the output oscillator 906 to be stored on the respective ones of the relay oscillators {ϕᵣ_{₁}, ϕᵣ_{₂}, . . . ϕᵣ_{_{N}}}.

On-chip classical controller 914 may be further configured to cause a second set of one or more pulses to be emitted, wherein the second set of pulses turns on the coupling between respective ones of the relay oscillators with sample values of the output oscillator 906 to an additional relay oscillator 1012. The coupling is configured to transfer an approximation of the expectation value of output oscillator 906 based at least in part on the sample values stored on respective relay oscillators in the first group of relay oscillators 1010. Once the additional relay oscillator 1012 is tuned to the expectation value of output oscillator 906, controller 914 may cause a set of one or more pulses that may cause the additional relay oscillator 1012 to be coupled to input oscillator 908. For ease of illustration a version that includes bias oscillators is shown. However, it should be understood that in some embodiments bias oscillators may be omitted.

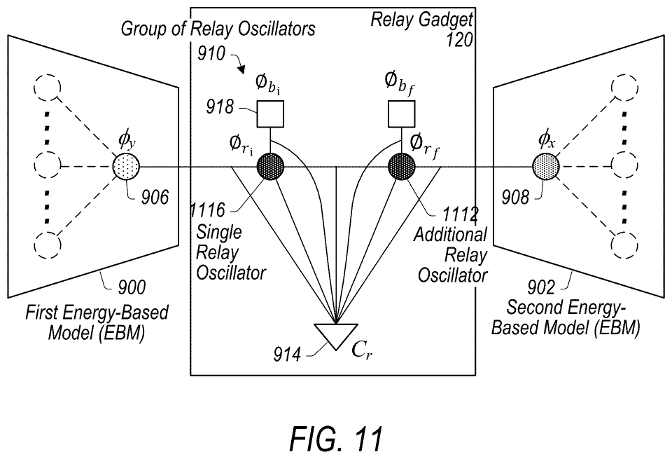

FIG. 11 is a high-level diagram illustrating a temporal analogue relay gadget, wherein a group of relay oscillators comprises a single relay oscillator, according to some embodiments.

In some embodiments, the group of relay oscillators 910 comprises a single relay oscillator 1116. The single relay oscillator 1116 is configured to store a sample of the output oscillator 906 based at least in part on the coupling between the single relay oscillator 1116 and the output oscillator 906. The coupling between output oscillator 906 and single relay oscillator 1116 is caused by a first set of one or more pulses emitted from on-chip classical controller 914. The on-chip classical controller 914 is configured to cause a second set of one or more pulses to be emitted, wherein the second set of pulses causes the single relay oscillator 1116 to be coupled to additional relay oscillator 1112. The sequence of emitting the first set of pulses and then emitting the second set of pulses may be repeated numerous times. Each instance the sequence of the sequential sets of pulses is emitted, the position of additional relay oscillator 1112 is incrementally adjusted. Each adjustment may converge the additional relay oscillator 1112 to the expectation value of output oscillator 906. For ease of illustration a version that includes bias oscillators is shown. However, it should be understood that in some embodiments bias oscillators may be omitted.

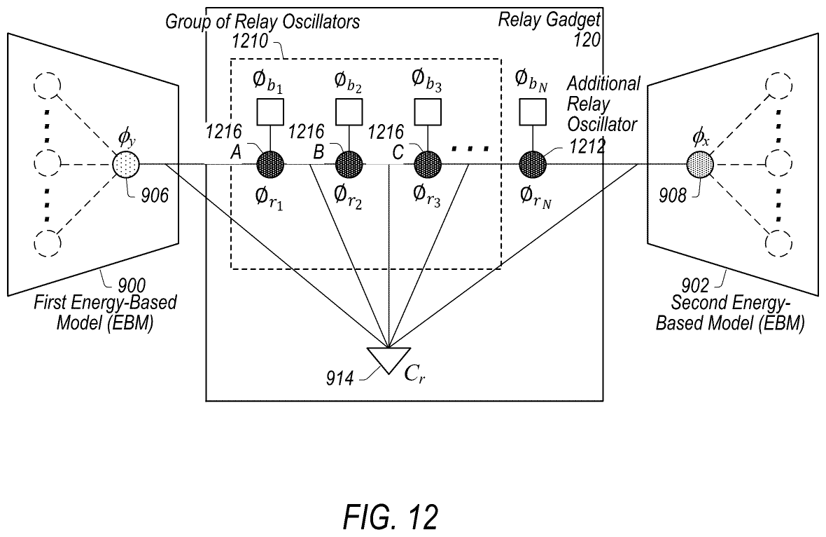

FIG. 12 is a high-level diagram illustrating a series analogue relay gadget, wherein a group of relay oscillators comprises a plurality of relay oscillators arranged in series, according to some embodiments.

FIG. 12 shows a drawing of a series analogue relay gadget 1204. The group of relay oscillators 910 comprises a plurality of relay oscillators {ϕᵣ_{₁}, ϕᵣ_{₂}, . . . } (e.g. relay oscillator 1216A, 1216B, 1216C) arranged one after another in series. Each relay oscillator has a product of mass and frequency squared. The first relay oscillator 1216A, ϕᵣ_{₁}, has the smallest product of mass and frequency squared. The next relay oscillator 1216B, ϕᵣ_{₂}, has a product of mass and frequency squared larger than the previous relay oscillator 1216A, ϕᵣ_{₁}. This trend of increasing the product of mass and frequency squared continues for each subsequent relay oscillator in the group of relay oscillators 910. As last in the chain of relay oscillators, the additional relay oscillator 1212 has the largest product of mass and frequency squared. The couplings between relay oscillators and the coupling between the output oscillator 906 and the first relay oscillator 1216A, ϕᵣ_{₁}, may be turned on at the same time and allowed to evolve thermodynamically according to Langevin dynamics. Once coupling is initiated, each successive relay oscillator takes continuous samples of the previous oscillator it is coupled to. Furthermore, each successive relay oscillator may be a closer approximation of the expectation value of the output oscillator 906. In this manner, additional relay oscillator 1212 approximates an expectation value of input oscillator 906. At this point, coupling between the additional relay oscillator 1212 and input oscillator 908 may be turned on and the thermodynamic information may be transferred to input oscillator 908. The number of relay oscillators and the timing of coupling may be chosen beforehand and optimized for a desired precision or accuracy of the expectation value of the output relay oscillator. For ease of illustration a version that includes bias oscillators is shown. However, it should be understood that in some embodiments bias oscillators may be omitted.

FIG. 13A illustrates example couplings between visible neurons of an energy-based model (EBM), according to some embodiments.

In some embodiments, input neurons and output neurons of an energy-based model, such as visible neurons 1302 and visible neurons 1304, may be directly linked via connected edges 1306. As shown in FIG. 13A, a given visible neuron 1302 of the five shown in the figure is connected, via edges 1306, to each of the respective three visible neurons 1304. A person having ordinary skill in the art should understand that FIG. 13A is meant to represent example embodiments of a graph architecture implemented using a thermodynamic chip that may be applied and that specific numbers of visible neurons 1302 and/or visible neurons 1304 shown in the figure are not meant to be restrictive. Additional configurations combining more/less visible neurons 1302 and/or visible neurons 1304 are also encompassed by the discussion herein. In addition, recall that neurons are logical representations of physical oscillators, such that, when describing neurons in FIGS. 13A and 13B, it should be understood that neurons and edges are implemented using oscillators and couplings.

FIG. 13B illustrates example couplings between visible neurons and non-visible neurons (e.g., hidden neurons) of an energy-based model (EBM), according to some embodiments.

In some embodiments, FIG. 13B may resemble additional example embodiments of an energy-based model architecture implemented using a thermodynamic chip. As shown in the figure, additional non-visible neurons 1308 may be used, which are respectively coupled, via edges 1306, to both visible neurons 1302 and to visible neurons 1304. Note that while the non-visible neurons are “not visible” from the perspective of inputs and outputs, the non-visible neurons may each correspond to a given oscillator. In addition, it may be noted that, in some embodiments that make use of non-visible neurons, no direct connections, via edges 1306, may be implemented between visible neurons 1302 and visible neurons 1304, but rather connections are routed firstly via non-visible neurons 1308, as shown in FIG. 13B. Couplings between visible and non-visible neurons may be additionally referred to herein as “layers” of a given energy-based model architecture that is implemented using a thermodynamic chip, according to some embodiments.

FIG. 14 is high-level diagram illustrating a process of determining weights and biases to be used in an energy-based model (EBM), wherein the weights and biases are determined using measurement values for synapse oscillators, according to some embodiments.

As shown in FIG. 14, in a first evolution, visible neurons of an energy-based model implemented on a thermodynamic chip 1402 may be clamped to input data. For example, multiple mini-batches of input data may be clamped to visible neurons for multiple evolutions used to generate a first set of measurements used to compute a positive phase term. For example, the measurements may be used by classical computing device 1404 to compute the positive phase term.

Also, in a second (or other subsequent) evolution, the visible neurons may remain unclamped, such that the visible neuron oscillators are free to evolve along with the synapse oscillators during the second (or other subsequent) evolution. Measurements may also be taken and used by the classical computing device 1404 to compute a negative phase term.

Additionally, the positive and negative phase terms computed based on the first and second sets of measurements (e.g., clamped measurements and un-clamped measurements) may be used to calculate updated weights and biases.

This process may be repeated, with the determined updated weights and biases used as initial weights and biases for a subsequent iteration. In some embodiments, inferences generated using the updated weights and biases may be compared to training data to determine if the energy-based model has been sufficiently trained. If so, the model may transition into a mode of performing inferences using the learned weights and biases.

If not sufficiently trained, the process may continue with additional iterations of determining updated weights and biases.

FIG. 15 is high-level diagram illustrating a process of determining weights and biases to be used in an energy-based model (EBM), wherein the weights and biases are computed using a classical computing device, according to some embodiments.

In some embodiments, updated weights and bias values may be computed iteratively by classical computing device 1504 based on inference measurements from thermodynamic chip 1502. For example, inference values may be compared to training data values, and new weights and biases may be iteratively computed until the inference values closely correspond to the training data. As can be seen in FIG. 15, in some embodiments the synapse oscillator may be omitted as degrees of freedom of the energy-based model. For example, when a classical computing device is used to iteratively determine the weight and bias values.

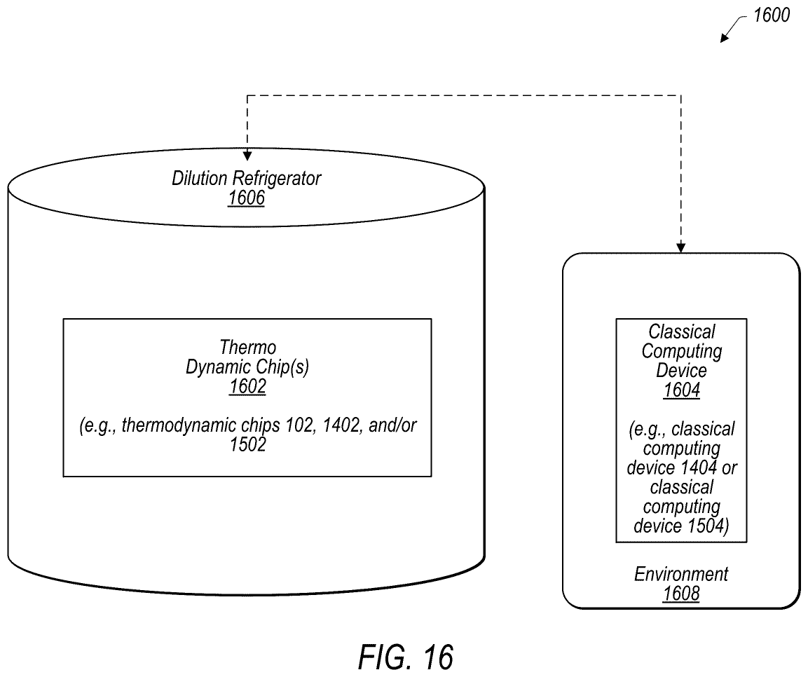

FIG. 16 is high-level diagram illustrating an example neuro-thermodynamic computer comprising a thermodynamic chip (e.g., that implements multiple energy-based models (EBMs) and a relay gadget) included in a dilution refrigerator and coupled to a classical computing device in an environment external to the dilution refrigerator, according to some embodiments.

In some embodiments, a neuro-thermodynamic computing system 1600 (as shown in FIG. 16) may be used to implement the various embodiments shown in FIGS. 1-15 and may include one or more thermodynamic chip(s) 1602 placed in a dilution refrigerator 1606. In some embodiments, classical computing device 1604 may control temperature for dilution refrigerator 1606, and/or perform other tasks, such as helping to drive a pulse drive to change respective hyperparameters of the given system and/or perform measurements, such as those shown in FIGS. 1-15. Also, the classical computing device 1604 may perform other simple computing operations, such as are needed to determine updated weights and biases.

In some embodiments, classical computing device 1604 may include one or more devices such as a field-programmable gate array (FPGA), an application specific integrated circuit (ASIC), and/or other devices that may be configured to interact and/or interface with a thermodynamic chip within the architecture of neuro-thermodynamic computer 1600. For example, such devices may be used to tune hyperparameters of the given thermodynamic system, etc. as well as perform part of the calculations necessary to determine updated weights and biases. In some embodiments, the classical computing device 1604 may be placed in an environment 1606 outside of the dilution refrigerator 1606.

As shown in FIG. 16, in embodiments where more than one thermodynamic chip is used with a relay gadget, multiple ones of the thermodynamic chips and the relay gadget may be placed in the same dilution refrigerator 1606.

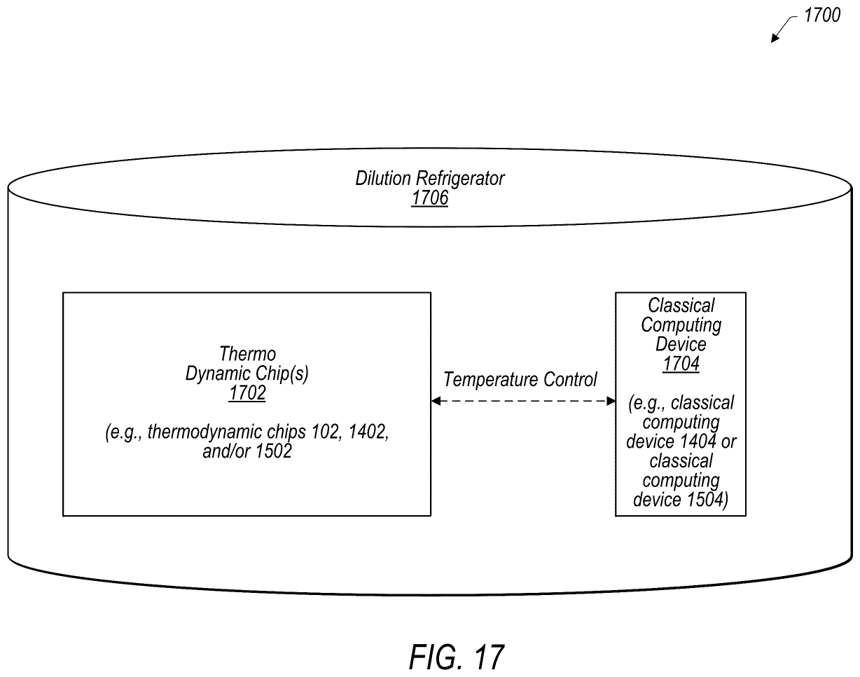

FIG. 17 is high-level diagram illustrating an example neuro-thermodynamic computer comprising a thermodynamic chip (e.g., that implements multiple energy-based models (EBMs) and a relay gadget) included in a dilution refrigerator and coupled to a classical computing device that is also included in the dilution refrigerator, according to some embodiments.

As another alternative, in some embodiments, a classical computing device used in a neuro-thermodynamic computer, such as in neuro-thermodynamic computer 1700, may be included in a dilution refrigerator with the thermodynamic chip. For example, neuro-thermodynamic computer 1700 includes both thermodynamic chip 1702 and classical computing device 1704 in dilution refrigerator 1706.

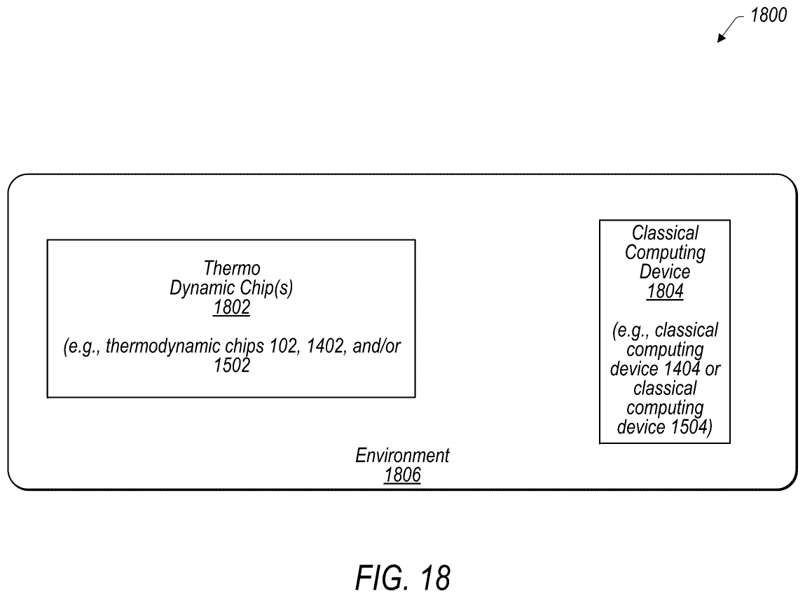

FIG. 18 is high-level diagram illustrating an example neuro-thermodynamic computer comprising one or more thermodynamic chips (e.g., that implement respective energy-based models (EBMs) and a relay gadget) coupled to a classical computing device in an environment other than a dilution refrigerator, according to some embodiments.

Also, in some embodiments, a neuro-thermodynamic computer, such as neuro-thermodynamic computer 1800, may be implemented in an environment other than a dilution refrigerator. For example, neuro-thermodynamic computer 1800 includes thermodynamic chip(s) 1802 and classical computing device 1804, in environment 1806. In some embodiments, environment 1806 may be temperature controlled and, the classical computing device (or other device) may control the temperature of environment 1806 in order to achieve a given level of evolution according to Langevin dynamics.

FIG. 19 is a high-level diagram illustrating oscillators included in a substrate of the thermodynamic chip and mapping of the oscillators to logical neurons of the thermodynamic chip, according to some embodiments.

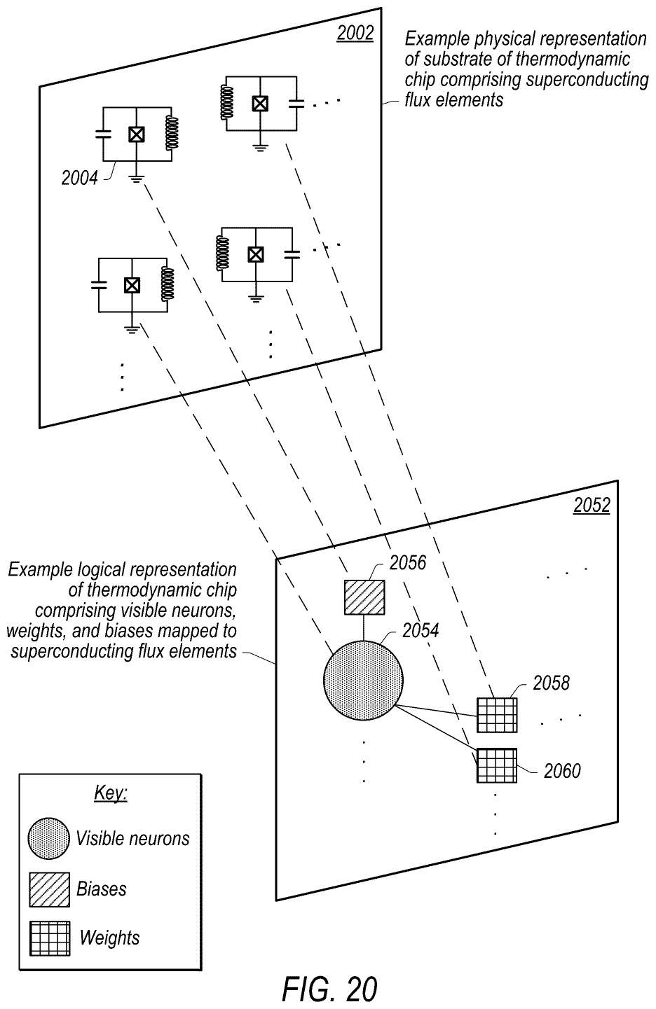

In some embodiments, a substrate 1902 may be included in a thermodynamic chip, such as any one of the thermodynamic chips described above. Oscillators 1904 of substrate 1902 may be mapped in a logical representation 1952 to neurons 1954, as well as weights and biases (shown in FIG. 20). In some embodiments, oscillators 1904 may include oscillators with potentials ranging from a single well potential to a dual-well potential and may be mapped to visible neurons, weights, and biases.

In some embodiments, Josephson junctions and/or superconducting quantum interference devices (SQUIDS) may be used to implement and/or excite/control the oscillators 1904. In some embodiments, the oscillators 1904 may be implemented using superconducting flux elements (e.g., qubits). In some embodiments, the superconducting flux elements may physically be instantiated using a superconducting circuit built out of coupled nodes comprising capacitive, inductive, and Josephson junction elements, connected in series or parallel, such as shown in FIG. 19 for oscillator 1904. However, in some embodiments, generally speaking various non-linear flux loops may be used to implement the oscillators 1904, such as those having single-well potential, double-well potential, or various other potentials, such as a potential somewhere between a single-well potential and a double-well potential.

FIG. 20 is an additional high-level diagram illustrating oscillators included in a substrate of the thermodynamic chip mapped to logical neurons, weights, and biases of a given neuro-thermodynamic computing system, according to some embodiments.

While weights and biases are not shown in FIG. 19 for ease of illustration, respective ones of the visible neurons 1954 of FIG. 19 may each have an associated bias, and edges connecting the neurons 1954 may have associated weights. Each of the weights and biases may be mapped to oscillators in the thermodynamic chip, as well as the visible (and non-visible) neurons being mapped to oscillators in the thermodynamic chip. For example, FIG. 20 shows a portion of a thermodynamic chip, wherein weights and biases associated with a given neuron 2054 are shown. For example, bias 2056 may be a bias value for visible neuron 2054 and weights 2058 and 2060 may be weights for edges formed between visible neuron 2054 and other visible neurons of the thermodynamic chip. As shown in FIG. 20, each of the chip elements (visible neuron 2054, bias 2056, weight 2058, and weight 2060) may be mapped to separate ones of oscillators 2004. This may allow the visible neurons (and/or hidden neurons), weights, and biases to have independent degrees of freedom within a given thermodynamic chip that can separately evolve.

In some embodiments, oscillators associated with weights and biases, such as bias 2056 and weights 2058 and 2060, may be allowed to evolve during a training phase and may be held nearly constant during an inference phase. For example, in some embodiments, larger “masses” may be used for the weights and biases such that the weights and biases evolve more slowly than the visible neurons. This may have the effect of holding the weight values and the bias values nearly constant during an evolution phase used for generating inference values.

### Illustrative Computer System

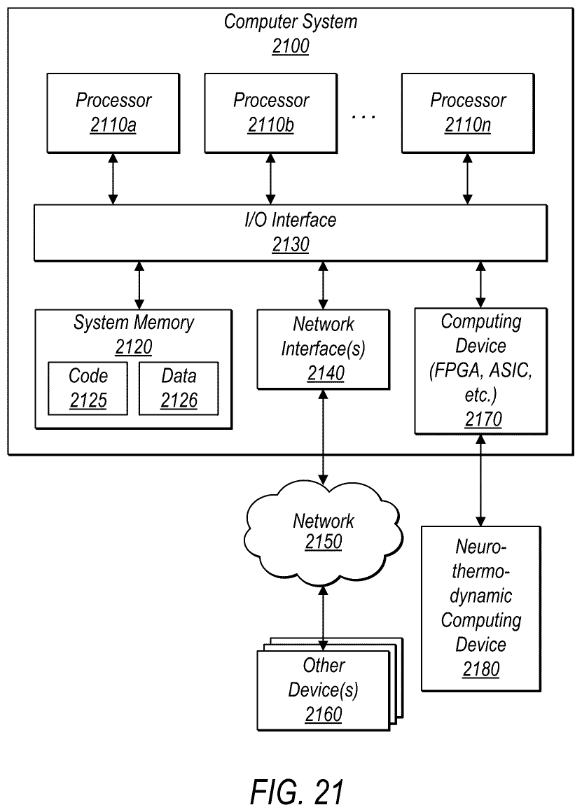

FIG. 21 is a block diagram illustrating an example computer system that may be used in at least some embodiments. In some embodiments, the computing system shown in FIG. 21 may be used, at least in part, to implement any of the techniques described above in FIGS. 1-20. Furthermore, computer system 2100 may be configured to interact and/or interface with neuro-thermodynamic computing device 2180, according to some embodiments.

In the illustrated embodiment, computer system 2100 includes one or more processors 2110 coupled to a system memory 2120 (which may comprise both non-volatile and volatile memory modules) via an input/output (I/O) interface 2130. Computer system 2100 further includes a network interface 2140 coupled to I/O interface 2130. Classical computing functions may be performed on a classical computer system, such as computing computer system 2100.

Additionally, computer system 2100 includes computing device 2170 coupled to thermodynamic chip 2180. In some embodiments, computing device 2170 may be a field programmable gate array (FPGA), application specific integrated circuit (ASIC) or other suitable processing unit. In some embodiments, computing device 2170 may be a similar computing device as described in FIGS. 1-20, such as classical computing devices used to control a thermodynamic chip. In some embodiments, neuro thermodynamic computing device 2180 may be a similar neuro thermodynamic computing device as described in FIGS. 1-20, such as neuro thermodynamic computing devices implemented using thermodynamic chips.

In various embodiments, computer system 2100 may be a uniprocessor system including one processor 2110, or a multiprocessor system including several processors 2110 (e.g., two, four, eight, or another suitable number). Processors 2110 may be any suitable processors capable of executing instructions. For example, in various embodiments, processors 2110 may be general-purpose or embedded processors implementing any of a variety of instruction set architectures (ISAs), such as the x86, PowerPC, SPARC, or MIPS ISAs, or any other suitable ISA. In multiprocessor systems, each of processors 2110 may commonly, but not necessarily, implement the same ISA. In some implementations, graphics processing units (GPUs) may be used instead of, or in addition to, conventional processors.

System memory 2120 may be configured to store instructions and data accessible by processor(s) 2110. In at least some embodiments, the system memory 2120 may comprise both volatile and non-volatile portions; in other embodiments, only volatile memory may be used. In various embodiments, the volatile portion of system memory 2120 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random-access memory (ReRAM), three-dimensional NAND technologies, Ferroelectric RAM, magneto resistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 2120 as code 2125 and data 2126.

In some embodiments, I/O interface 2130 may be configured to coordinate I/O traffic between processor 2110, system memory 2120, computing device 2170, and any peripheral devices in the computer system, including network interface 2140 or other peripheral interfaces such as various types of persistent and/or volatile storage devices. In some embodiments, I/O interface 2130 may perform any necessary protocol, timing or other data transformations to convert data signals from one component (e.g., system memory 2120) into a format suitable for use by another component (e.g., processor 2110). In some embodiments, I/O interface 2130 may include support for devices attached through various types of peripheral buses, such as a variant of the Peripheral Component Interconnect (PCI) bus standard or the Universal Serial Bus (USB) standard, for example. In some embodiments, the function of I/O interface 2130 may be split into two or more separate components, such as a north bridge and a south bridge, for example. Also, in some embodiments some or all of the functionality of I/O interface 2130, such as an interface to system memory 2120, may be incorporated directly into processor 2110.

Network interface 2140 may be configured to allow data to be exchanged between computing device 2100 and other devices 2160 attached to a network or networks 2150, such as other computer systems or devices. In various embodiments, network interface 2140 may support communication via any suitable wired or wireless general data networks, such as types of Ethernet network, for example. Additionally, network interface 2140 may support communication via telecommunications/telephony networks such as analog voice networks or digital fiber communications networks, via storage area networks such as Fibre Channel SANs, or via any other suitable type of network and/or protocol.

In some embodiments, system memory 2120 may represent one embodiment of a computer-accessible medium configured to store at least a subset of program instructions and data used for implementing the methods and apparatus discussed in the context of FIG. 1 through FIG. 16. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computer system 2100 via I/O interface 2130. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computer system 2100 as system memory 2120 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 2140. Portions or all of multiple computing devices such as that illustrated in FIG. 21 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computer system”, as used herein, refers to at least all these types of devices, and is not limited to these types of devices.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures above are described herein represent exemplary embodiments of methods. The methods may be implemented in software, hardware, or a combination thereof. The order of method may be changed, and various elements may be added, reordered, combined, omitted, modified, etc.

It will also be understood that, although the terms first, second, etc., may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A system comprising:
one or more thermodynamic chips, comprising:
a first set of oscillators; and
a second set of oscillators configured to perform a SoftMax function, wherein to perform the SoftMax function, the second set of oscillators are configured to:
couple to the first set of oscillators, wherein the first set of oscillators have a first set of respective values; and
thermodynamically evolve based on an engineered potential for the second set of oscillators, wherein the engineered potential thermodynamically implements the SoftMax function,
wherein the thermodynamic evolution based on the engineered potential causes the second set of oscillators to change from the first set of respective values to a second set of respective values, wherein the second set of respective values are limited, by the engineered potential, to values of zero or one, and wherein the second set of values sums to one.

2. The system of claim 1, wherein to implement the engineered potential, the respective oscillators of the second set of oscillators are dual-well oscillators with valleys at the values of one and zero.

3. The system of claim 1, wherein to implement the engineered potential, the respective oscillators of the second set of oscillators are coupled to one another with coupling terms that cause the second set of oscillators to have values that sum to one.

4. The system of claim 3, wherein the second set of oscillators are coupled to one another in an all-to-all coupling configuration.

5. The system of claim 3, wherein the second set of oscillators are coupled to one another using one or more ancilla oscillators that form a modified tree structure to couple the second set of oscillators to one another.

6. The system of claim 5, wherein respective ones of the ancilla oscillators in the modified tree structure are connected to a parent ancilla oscillator, two child ancilla oscillators, and a sibling ancilla oscillator in the modified tree structure, and
wherein the respective ones of the oscillators of the second set of oscillators are connected to an ancilla oscillator and a sibling oscillator of the second set of oscillators, wherein the sibling pair of oscillators are coupled to a same parent ancilla oscillator.

7. The system of claim 1, further comprising:
a third set of oscillators configured to implement an energy-based model,
wherein the first set of oscillators are relay oscillators configured to relay information between the third set of oscillators that implement the energy-based model and the second set of oscillators that implement the SoftMax function.

8. The system of claim 7, wherein the relay oscillators are configured to have adjustable mass and/or frequencies.

9. The system of claim 1, further comprising:
additional sets of oscillators that implement a plurality of energy-based models of a machine learning transformer model, wherein the second set of oscillators configured to implement the SoftMax function perform SoftMax operations used in implementing the machine learning transformer model.

10. The system of claim 1, wherein the first and second set of values are encoded using a position degree of freedom of the respective oscillators.

11. A thermodynamic SoftMax gadget comprising:
a set of oscillators configured to:
couple to another set of oscillators, wherein the other set of oscillators have a first set of respective values; and
thermodynamically evolve based on an engineered potential, wherein the engineered potential thermodynamically implements a SoftMax function, and
wherein the thermodynamic evolution based on the engineered potential causes the oscillators of the set of oscillators to evolve to a one-hot vector, comprising a single oscillator of the set having a value of one and all other oscillators of the set having a value of zero.

12. The thermodynamic SoftMax gadget of claim 11, wherein to implement the engineered potential:
the respective oscillators of the set of oscillators are dual-well oscillators with valleys at the values of one and zero; and
the respective oscillators of the set of oscillators are coupled to one another with coupling terms that cause the oscillators to have values that sum to one.

13. The thermodynamic SoftMax gadget of claim 11, wherein the set of oscillators are coupled to one another in an all-to-all coupling configuration.

14. The thermodynamic SoftMax gadget of claim 11, wherein the set of oscillators are coupled to one another using one or more ancilla oscillators that form a modified tree structure to couple the oscillators of the set to one another.

15. The thermodynamic SoftMax gadget of claim 14, wherein respective ones of the ancilla oscillators in the modified tree structure are connected to a parent ancilla oscillator, two child ancilla oscillators, and a sibling ancilla oscillator in the modified tree structure.

16. The thermodynamic SoftMax gadget of claim 15, wherein the respective ones of the oscillators of the set are connected to an ancilla oscillator and a sibling oscillator of the set, wherein the sibling pair of oscillators are coupled to a same parent ancilla oscillator.

17. The thermodynamic SoftMax gadget of claim 11, wherein the set of oscillators are relay oscillators with time dependent mass or frequency.

18. A method, comprising:
coupling a set of output oscillators of an energy-based model to a set of oscillators of a SoftMax gadget; and
causing the oscillators of the SoftMax gadget to thermodynamically evolve based on an engineered potential, wherein the engineered potential thermodynamically implements a SoftMax function.

19. The method of claim 18, further comprising:
coupling, subsequent to the thermodynamic evolution, the oscillators of the SoftMax gadget to another set of oscillators, wherein a result of the SoftMax function is transferred to the other set of oscillators.

20. The method of claim 18, wherein the set of oscillators are coupled to one another in an all-to-all coupling configuration.

21. The method of claim 18, wherein the set of oscillators are coupled to one another using one or more ancilla oscillators that couple the oscillators of the set to one another.
